(19) United States
(12) Patent Application Publication
(10) Pub. No.: US 2013/0278727 A1
(43) Pub. Date: Oct. 24, 2013

(54) METHOD AND SYSTEM FOR CREATING THREE-DIMENSIONAL VIEWABLE VIDEO FROM A SINGLE VIDEO STREAM

(71) Applicants: Michael Tamir, Tel Aviv (IL); Itzhak Wilf, Yahud-Monoson (IL); Shai Sabag, Binyamina (IL); Rotem Littman, Bnei Brak (IL); Michael Birnboim, Holon (IL)

(72) Inventors: Michael Tamir, Tel Aviv (IL); Itzhak Wilf, Yahud-Monoson (IL); Shai Sabag, Binyamina (IL); Rotem Littman, Bnei Brak (IL); Michael Birnboim, Holon (IL)

(73) Assignee: STERGEN HIGH-TECH LTD., Tel Aviv (IL)

(21) Appl. No.: 13/824,470

(22) PCT Filed: Nov. 24, 2011
(86) PCT No.: PCT/IB11/55279

§ 371 Date: Jul. 9, 2013

Related U.S. Application Data
(60) Provisional application No. 61/416,759, filed on Nov. 24, 2010.
(60) Provisional application No. 61/427,187, filed on Dec. 26, 2010.

(51) Int. Cl. H04N 13/02

(52) U.S. Cl. CPC H04N 13/0239
USPC 348/47

(57) ABSTRACT

Generating 3D representations of a scene represented by a first video stream captured by video cameras. Identifying a transition between cameras, retrieving parameters of a first set of viewing configurations, providing 3D video representations representing the scene at several sets of viewing configurations different from the first set of viewing configurations, and generating an integrated video stream enabling 3D display of the scene by integration of at least two video streams having respective sets of viewing configurations, which are mutually different. Another provided process is for synthesizing an image of an object from a first image, captured by a certain camera at a first viewing configuration. Assigning a 3D model to a portion of a segmented object, calculating a modified image of the portion of the object from a viewing configuration different from the first viewing configuration, and embedding the modified image in a frame for stereoscopy.

### CROSS REFERENCE WITH RELATED APPLICATIONS

This patent application claims the priority benefits of U.S. provisional patent application No. 61/416,759 entitled “METHOD AND SYSTEM FOR CREATING THREE-DIMENSIONAL VIEWABLE VIDEO FROM A SINGLE VIDEO STREAM” filed 24 Nov. 2010 by Miky Tamir, Itzhak Wilf, Shai Sabag, Rotem Littman, and Michael Birnboim. This patent application also claims the priority benefits of U.S. provisional patent application No. 61/427,187 entitled “METHOD AND SYSTEM FOR COMBINING GRAPHICS WITH THREE-DIMENSIONAL VIDEO” filed 26 Dec. 2010 by Itzhak Wilf and Miky Tamir. The current patent is a Continuation In Part (CIP), where CIP applies, of international patent application No. PCT/IB10/51500 entitled “METHOD AND SYSTEM FOR CREATING THREE-DIMENSIONAL VIEWABLE VIDEO FROM A SINGLE VIDEO STREAM” filed 7 Apr. 2010 by STERGEN HI-TECH LTD.

### BACKGROUND OF THE INVENTION

1. Field of the Invention

The invention is in the field of three dimensional (3D) real time and offline video production and more particularly stereo and multi-view synthesis for 3D production of sports events.

2. Description of Related Art

The use of 3D productions in theatres and home television is spreading out. Some studies indicate that there are about 1,300 3D equipped theaters in the U.S. today and that the number could grow to 5,000 by the end of 2009. The study, “3-D TV: Where are we now and where are consumers” shows that 3D technology is positioned to become a major force in future in-home entertainment. As with many successful technologies, such as HDTV, interest in 3D increases as consumers experience it first-hand. In 2008, nearly 41 million U.S. adults report having seen a 3D movie in theaters. Of those, nearly 40% say they would prefer to watch a movie in 3D than in 2D, compared to just 23 percent who have not seen a 3D movie in 2008.

The study also found that present 3D technology is becoming a major purchasing factor of TV sets. 16% percent of consumers are interested in watching 3D movies or television shows in their home, while 14% are interested in playing 3D video games. All told, more than 26 million households are interested in having a 3-D content experience in their own home. More than half of U.S. adults said having to wear special glasses or hold their heads still while watching a 3D TV would have no impact on them purchasing a 3D set for their home.

The 3D experience is probably much more intense and significant than prior broadcast revolutions such as black/white to color and the move to HDTV.

As usual, sports productions are at the forefront of the 3D revolution as with all prior innovations. There are many examples to that:
Sony Electronics has struck a deal with Fox Sports to sponsor the network's 3D HD broadcast of the FedEx Bowl Championship Series (BCS) college football national championship game.
In 2008, for the very first time at Roland Garros, Orange was going to film and broadcast live its first 3D sports contents for its guests.
BBC engineers have broadcasted an entire international sporting event live in 3D for the first time in the UK, as Scotland's defeat of England in the Six Nations rugby union championship was relayed to a London cinema audience.
2008's IBC show saw Wige data, a big European sports producing company entering the 3D fray. Joining forces with fellow German manufacturer MikroM and 3D rig specialist 3ality, Wige demonstrated a 3D wireless bundle which combines its CUNIMA MCU camera, MikroM's Megacine field recorder and a 3ality camera rig.
Speaking at the Digital TV Group's annual conference, Sky's Chief engineer Chris Johns revealed: ‘At the moment we are evaluating all of the mechanisms to deliver 3D, and are building a content library of 3D material for the forthcoming year.’ Johns confirmed delivery will be via the current Sky+ HD set top box, but says viewers will need to buy ‘a 3D capable TV’ to enjoy the service. He added: When sets come to market, we want to refine 3D production techniques and be in a position to deliver first generation, self-generated 3D content.’
The US National Football League has been broadcasted live in 3D few games demonstrating that the technology can be used to provide a more realistic experience in a theater or in the home.

Vendors of TV sets are already producing “3D ready” sets; some are based on eyeglasses technologies [see ref. I] wherein the viewers are wearing polarization or other types of stereo glasses. Such TV sets require just two different stereoscopic views. Other 3D sets are auto-stereoscopic [see ref. 2] and as such require multiple views (even 9 views for each frame!) to serve multiple viewers that watch television together.

There are several technologies for auto-stereoscopic 3D displays. Presently, most flat-panel solutions employ lenticular lenses or parallax barriers that redirect incoming imagery to several viewing regions at a lower resolution. If the viewer positions his/her head in certain viewing positions, he/she will perceive a different image with each eye, giving a stereo image. Such displays can have multiple viewing zones allowing multiple users to view the image at the same time. Some flat-panel auto-stereoscopic displays use eye tracking to automatically adjust the two displayed images to follow viewers' eyes as they move their heads. Thus, the problem of precise head-positioning is ameliorated to some extent.

The 3D production is logistically complicated. Multiple cameras (two in the case of a dual-view, multiple in the case of a multi-view production) need to be boresighted (aligned together), calibrated and synchronized. Bandwidth requirements are also much higher in 3D.

Naturally these difficulties are enhanced in the case of outdoor productions such as coverage of sports events. Additionally, all the stored and archived footage of the TV stations is in 2D.

It is therefore the purpose of the current invention to offer a system and method to convert a single stream of conventional 2D video into a dual view or multi-view 3D representations for both archived sports footage as well as live events. It is our basic assumption that the converted footage should be in a very high quality and should adhere to the standards of the broadcast industry.

Existing automatic 2D to 3D conversion methods create depth maps using cues such as objects motion, occlusion and other features [3,4]. According to our best judgment these methods cannot provide the quality required by broadcasters nor the synthesis of multiple views required in a multi-view 3D display.

### LIST OF PRIOR ART PUBLICATIONS

### Hereafter References or Ref

1. “Samsung unveils world's 1^{st} 3D plasma TV”, The Korea Times, Biz/Finance, Feb. 28, 2008.
2. http://www.obsessable.com/news/2008/10/02/philips-exhibits-56-inch-autostereoseopic-quad-hd-3d-tv/3.
3. M. Pollefeys, R. Koch, M. Vergauwen, L. Van Gool, “Automated reconstruction of 3D Scenes from Sequences of Images”, ISPRS Journal of Photogrammetry and Remote Sensing (55) 4, pp. 251-267, 2000.
4. C. Tomasi, T. Kanade, “Shape and Motion from Image Streams: A Factorization Method”, Journal of Computer Vision 9(2), pp. 137-154, 1992.
5. “Methods of scene change detection and fade detection for indexing of video sequences”, Inventors: Divakaran, Ajay; Sun, Huifang; Ito, Hiroshi; Poon, Tommy C.; Assignee: Mitsubishi Electric Research Laboratories, Inc. (Cambridge, Mass.).
6. “Digital chromakey apparatus”, U.S. Pat. No. 4,488,169 to Kaichi Yamamoto.
7. “Keying methods for digital video”, U.S. Pat. No. 5,070,397, to Thomas Wedderburn-Bisshop.
8. “Block matching-based method for estimating motion fields”, U.S. Pat. No. 6,285,711 to Krishna Ratakonda, M. Ibrahim Sezan.
9. “Pattern recognition system”, U.S. Pat. No. 4,817,171 to Frederick W. M. Stentiford.
10. “Image recognition edge detection method and system”, U.S. Pat. No. 4,969,202 to John L. Groezinger.
11. “Tracking players and a ball in video image sequences and estimating camera parameters for soccer games”, Yamada, Shirai, Miura, dept. of computer controlled mechanical systems, Osaka university.
12. “Optical flow detection system”, U.S. Pat. No. 5,627,905 to Thomas J. Sebok, Dale R. Sebok.
13. “Enhancing a video of an event at a remote location using data acquired”, U.S. Pat. No. 6,466,275 to Stanley K. Honey, Richard H. Cavallaro, Jerry N. Gepner, James R. Gloudemans, Marvin S. White.
14. “System and method for generating super-resolution-enhanced mosaic”, U.S. Pat. No. 6,434,280 to Shmuel Peleg, Assaf Zomet.

### BRIEF SUMMARY OF THE INVENTION

It is provided according to some embodiments of the present invention, a method for generating a three-dimensional representation of a scene. The scene is represented by a first video stream captured by a certain camera at a first set of viewing configurations. The method includes providing video streams compatible with capturing the scene by cameras, and generating an integrated video stream enabling three-dimensional display of the scene by integration of two video streams, the first video stream and one of the provided video streams, for example. The sets of viewing configurations related to the two video streams are mutually different.

A viewing configuration of a camera capturing the scene is characterized by parameters like parameters of geographical viewing direction, parameters of geographical location, parameters of viewing direction relative to elements of the scene, parameters of location relative to elements of the scene, and lens parameters like zooming or focusing parameters.

In some embodiments, parameters characterizing a viewing configuration of the first camera are measured by devices like encoders mounted on motion mechanisms of the first camera, potentiometers mounted on motion mechanisms of the first camera, a global positioning system device, an electronic compass associated with the first camera, or encoders and potentiometers mounted on camera lens.

In some embodiments, the method includes the step of calculating parameters characterizing a viewing configuration by analysis of elements of the scene as captured by the certain camera in accordance with the first video stream.

In some embodiments, the method includes determining a set of viewing configuration different from the respective set of viewing parameters associated with the first video stream. Alternatively, a frame may be synthesized directly from a respective frame of the first video stream by perspective transformation of planar surfaces.

Known geometrical parameters of the certain element are used for calculating the viewing configuration parameters. For example, a sport playing field is a major part of the scene, and its known geometrical parameters are used for calculating viewing configuration parameters. A pattern recognition technique may be used for recognizing a part of the sport playing field.

In some embodiments, the method includes identifying global camera motion during a certain time period, calculating parameters of the motion, and characterizing viewing configuration relating to a time within the certain time period based on characterized viewing configuration relating to another time within the certain time period.

In some embodiments, the method includes the step of shaping a video stream such that a viewer senses a three dimensional scene upon integrating the video streams and displaying the integrated video stream to the viewer having corresponding viewing capability. In one example, the shaping is effecting spectral content and the viewer has for each eye one a different color glass. In other example the shaping is effecting polarization, and the viewer has for each eye a different polarizer glass. In another example, known as “active shutter glasses”, shaping refers to displaying left and right eye images in an alternating manner on a high frame rate display, and using suitable active glasses that switch the left and right eye filters, on and off in synchronization with the display. For that, the consecutive frames of at least two video streams are arranged alternately in accordance with appropriate display and view system.

In some embodiments, the first camera captures the first video stream while in motion, and one of the integrated video streams is a video stream captured by the first camera at timing shifted relative to the first video stream. Thus, the generated video stream includes superimposed video streams representative of different viewing configurations at a time.

In some embodiments, the method includes synthesizing frames of a video stream by associating a frame of the first video stream having certain viewing configuration to a different viewing configuration. The contents of the frame of the first video stream are modified to fit the different viewing configuration, and the different viewing configuration is selected for enabling three-dimensional display of the scene. The method may include the step of segmenting an element of the scene appearing in a frame from a rest portion of a frame. Such segmenting is facilitated chromakeying, lumakeying, or dynamic background subtraction, for example.

In some embodiments, the scene is a sport scene including a playing field, a group of on-field objects and a group of background objects. The method includes segmenting a frame to the playing field, the group of on-field objects and the group of background objects, separately associating each portion to the different viewing configuration, and merging them into a single frame.

Also, the method may include the steps of calculating of on-field footing locations of on-field objects in a certain frame of the first video stream, computing of on-field footing locations of on-field objects in a respective frame associated with a different viewing configuration, and transforming the on-field objects from the certain frame to the respective frame as a 2D object.

Furthermore, the method may include synthesizing at least one object of the on-field objects by the steps of segmenting portions of the object from respective frames of the first video stream, stitching the portions of the object together to fit the different viewing configuration, and rendering the stitched object within a synthesized frame associated with the different viewing configuration.

In some embodiments, a playing object is used in the sport scene and the method includes the steps of segmenting the playing object, providing location of the playing object, and generating a synthesized representation of the playing object for merging into a synthesized frame fitting the different viewing configuration.

In some embodiments, an angle between two scene elements is used for calculating the viewing configuration parameters. Similarly an estimated height of a scene element may be used for calculating the viewing configuration parameters. Relevant scene elements are players, billboards and balconies.

In some embodiments, the method includes detecting playing field features in a certain frame of the first video stream. Upon absence of sufficient feature data for the detecting, other frames of the first video stream are used as a source of data to facilitate the detecting.

It is provided according to some embodiments of the present invention, a system for generating a three-dimensional representation of a scene. The system includes a synthesizing module, and a video stream integrator. The synthesizing module provides video streams compatible with capturing the scene by cameras. Each camera has a respective set of viewing configurations different from the first set of viewing configurations. The video stream integrator generates an integrated video stream enabling three-dimensional display of the scene by integration of two video streams, the first video stream and one provided video streams, for example.

In some embodiments, the system includes a camera parameter interface for receiving parameters characterizing a viewing configuration of the first camera from devices relating to the first camera.

In some embodiments, the system includes a viewing configuration characterizing module for calculating parameters characterizing a viewing configuration by analysis of elements of the scene as captured by the certain camera in accordance with the first video stream.

In some embodiments, the system includes a scene element database and a pattern recognition module adapted for recognizing a scene element based on data retrieved from the scene element database and calculate viewing configuration parameters in accordance with the recognizing and the element data.

In some embodiments, the system includes a global camera motion module adapted for identifying global camera motion during a certain time period, calculating parameters of the motion, characterizing viewing configuration relating to a time within the certain time period based on characterized viewing configuration relating to another time within the certain time period, and time shifting a video stream captured by the first camera relative to the first video stream, such that the generated video stream including superimposed video streams having different viewing configurations at a time.

In some embodiments, the system includes a video stream shaping module for shaping a video stream for binocular 3D viewing. It also may include a segmenting module for segmenting an element of the scene appearing in a frame from a rest portion of a frame.

The system, or a part of the system, may be located in a variety of places, near the first camera, in a broadcast studio, or in close vicinity of a consumer viewing system. The system may be implemented on a processing board comprising a field programmable gate array, or a digital signal processor.

It is provided according to some embodiments of the present invention, a method for generating a three-dimensional representation of a scene including at least one element having at least one known spatial parameter. The method includes extracting parameters of the first set of viewing configurations using the known spatial parameter of the certain element, and calculating intermediate set of data relating to the scene based on the first video stream, and on the extracted parameters of the first set of viewing configurations. The intermediate set of data may include depth data of elements of the scene. The method may also include using the intermediate set of data for synthesizing video streams compatible with capturing the scene by cameras, and generating an integrated video stream enabling three-dimensional display of the scene by integration of two video streams, the first video stream and one synthesized video stream, for example. The sets of viewing configurations related to the two video streams are mutually different.

In some embodiments, tasks are divided between a server and a client and the method includes providing the intermediate set of data to a remote client, which uses the intermediate set of data for providing video streams compatible with capturing the scene by cameras, and generates an integrated video stream enabling three-dimensional display of the scene by integration of two video streams having mutually different sets of viewing configurations.

It is provided according to some embodiments of the present invention, a process for generating several 3D representations of a scene, whereas the scene is represented by a first video stream captured by several video cameras. The method includes identifying a transition between cameras, retrieving parameters of a first set of viewing configurations, providing several 3D video representations representing the scene at several sets of viewing configurations different from the first set of viewing configurations, and generating an integrated video stream enabling 3D display of the scene by integration of at least two video streams having respective sets of viewing configurations, which are mutually different.

It is provided according to some embodiments of the present invention, a process for synthesizing an image of portion of an object from a first image, the first image is a part of a frame captured by a certain camera at a first viewing configuration. The process includes segmenting the portion of the object from the frame, assigning a 3D model to the portion of the object, in accordance with the 3D model, calculating a modified image of the portion of the object from a viewing configuration different from the first viewing configuration, and embedding the modified image in a frame of an integrated video stream enabling three-dimensional display of the scene.

In some embodiments, the 3D model is a flat surface, a cylinder, an elongated body having a uniform elliptical cross-section, or a 3D human shape model. Alternatively, the 3D model is represented by a collection of surface patches.

It is provided according to some embodiments of the present invention, a process for synthesizing an image of an object from a first image of the object, whereas the first image is a part of a frame captured by a first camera at a first viewing configuration. The process includes segmenting the object from a rest portion of the frame to get a first segmented image of the object, identifying the object in a second image captured by a second camera at a second viewing configuration, generating a modified image of the object in accordance with the first segmented image of the object and the second image, and embedding the modified image in a frame of an integrated video stream enabling 3D display of the scene.

In some embodiments, the process includes segmenting a part of the object from a rest portion of the second image, and stitching that part into a modified image of the object.

In some embodiments, the captured scene is a sport scene which includes a playing field, on-field objects and background objects. Preferably, the object is a portion of the playing field, a player, or a background object.

In some embodiments, the process includes calculating a plurality of depth values based on the first image and the second image, and generating a modified image of the object in accordance with the plurality of depth values.

In some embodiments, the process includes, based on footing location of the object, segmenting the object from a rest portion of a frame to get a first segmented image of the object.

It is disclosed according to certain embodiments of the current invention, a process for synthesizing an image of a on-field object captured in several frames by a certain camera at a first set of viewing configuration of a sports scene. The on-field object is identified in a first certain frame. The first certain frame is transformed to a first respective frame associated with a different set of viewing configurations, whereas the first viewing configuration and the different set of viewing configurations are suitable for two eye stereoscopy, The process includes identifying the on-field object in a second certain frame, transforming a portion of the second frame to a second respective frame associated with a different set of viewing configuration, and embedding the on-field object in the second respective frame such that the second certain frame of the two or more frames and the respective frame fitting two eye stereoscopy. The resulted respective frame is different from a frame obtained by transforming the whole second frame in accordance with the different set of viewing configurations.

In some embodiments, the identifying of the on-field object is facilitated by footing locations in both the first certain frame and the second certain frame, object tracking between subsequent frames, or identifying a feature associated with the first object in both the first certain frame and the second certain frame.

In some embodiments, a disparity value distribution of the embedded on-field object is determined in accordance with a calculated disparity value distribution of an surface underlying the on-field object. Preferably, the disparity value distribution of the embedded the on-field object is perturbed in a series of frames having the different set of viewing configurations around a calculated disparity value distribution of the underlying surface. The perturbations are by a small differential disparity value such as to visually separate the first object from the underlying surface. Preferably, the disparity value distribution of the embedded on-field object is modified continuously between a frame having separated on-field objects and a frame where the on-field objects are not separated.

It is provided according to some embodiments of the present invention, a process for presenting a playing object in a sports scene from a first series of images of the sports scene, whereas the first series of images is captured at a respective first set of viewing configurations of the sports scene. The process includes identifying the playing object in the first series of images to get identified playing objects in respective images, segmenting an identified playing object from the rest of a respective image, calculating depth values associated with the segmented playing object, and synthesizing a second series of images of the playing object fitting a second set of viewing configurations. For the synthesis, use is made for each image of the second series, of the respective calculated depth values. The second set of viewing configuration is different from the first set of viewing configurations, such as to support a 3D display of the sports scene. Preferably, the playing object is identified using color based detection, shape based detection or motion based detection.

In some embodiments, the process includes transforming a first representation of an air trajectory of the playing object as captured in the first series of images to a second representation of the air trajectory in accordance with the second set of the viewing configurations. For that sake the process preferably includes, based on the first representation of the air trajectory, determining world representation of a plane disposed vertical to an horizontal plane and hosting the air trajectory, calculating world representation of the air trajectory, and calculating disparity values along the air trajectory in accordance with the second set of viewing configurations based on the calculated world representation of the air trajectory. Preferably, the process includes determining on-field endpoints of the air trajectory.

In some embodiments, the process includes measuring a size of the playing object in the first representation of the playing object, and determining the depth and the disparity of the object based on its size. Alternatively, the process includes measuring the size of the playing object in perpendicular to a motion vector associated with the air trajectory. Preferably, the process includes smoothing the measurements of the size of the playing object based on a monotonous change along the air trajectory.

It is provided according to some embodiments of the present invention, A process for presenting a static object in a sports scene based on a first image of the sports scene captured at a first viewing configuration, whereas the static object resides on a plane different from the field surface. The process includes, based on a model of the static object and position relative to other static object, transforming a first representation of the static object in the first series of images to a second representation fitting a second viewing configuration different from the first viewing configuration, identifying a part of the static object as being absent in the first representation of the static object, and as being present in the second representation of the static object, and in-painting that part of the static object.

As s source for in-painting, use is made of an image captured at a viewing configuration different from the first viewing configuration, a prior model of the static object, or a similar object located in a other field location. Exemplary static objects are a goal post, a tennis net, a basket poll, a billboard, a gallery, a balcony and a tribune.

It is provided according to some embodiments of the present invention, a client process for generating a local 3D representation of a scene in accordance with local displaying parameters. The method includes receiving from a server an intermediate set of data associated with the first video stream, using local displaying parameter to provide several video streams compatible with different viewing configurations, and locally generating an integrated video stream enabling 3D display of the scene by integration of two video streams having different respective sets of viewing configurations.

In some embodiments, a non-volatile memory of a displaying platform stores at local displaying parameters, like display size, viewing distance, and range of viewing angles. Exemplary displaying devices are a 3D projector, a home cinema display, a computer monitor, and a tablet display.

It is provided according to some embodiments of the present invention, a process for generating a 3D representation of a scene as seen by a camera pair moving compatibly for creating a 3D display of the scene. The method includes providing several video streams representing the scene from viewpoints of several moving cameras having a different set of viewing configurations, generating an integrated video stream enabling three-dimensional display of the scene by moving cameras. preferably, the moving camera pair moves along a trajectory lower than an original camera.

It is provided according to some embodiments of the present invention, a process for embedding a graphic element in several series of images, whereas respective images from the several series support three-dimensional display of a scene. The process includes identifying an object in respective images relating to a certain scene, calculating depth value associated with the identified object at the respective images, and rendering the graphic element in accordance with a depth value of the identified object within the respective images relating to a certain scene.

In some embodiments, the process further includes selecting an object for association with a graphic element, tracking the identified object along a trajectory of varying depth value; and keeping the graphic element in substantially constant relationship with the tracked object.

### BRIEF DESCRIPTION OF THE DRAWINGS

The subject matter regarded as the invention is particularly pointed out and distinctly claimed in the concluding portion of the specification. The invention, however, both as to system organization and method of operation, together with features and advantages thereof, may best be understood by reference to the following detailed description when read with the accompanied drawings in which:

FIG. 1a is a block diagram of a system for generating 3D video streams.

FIG. 1b schematically illustrates a real camera and a virtual camera viewing a scene to get a 3D representation of the scene.

FIG. 2 is a flow chart of a method for generating a 3D representation of a scene.

FIG. 3 is a flow chart of a method for generating a 3D display using a moving camera.

FIG. 4 is a block diagram of a system for generating 3D video streams of a sport scene.

FIG. 5 illustrates segmenting portions of a sport scene, synthesizing the portions and merging them.

FIG. 6a is a flow chart of a method for on-field objects.

FIG. 6b is a flow chart of a method for an object made of portions from several frames.

FIG. 7 is a flow chart of a method used in generating 3D video streams of a sport event.

FIG. 8a illustrates pattern recognition of a scene element.

FIG. 8b illustrates a playing field used in the pattern recognition of FIG. 8a.

FIG. 9 is a flow chart of a server method for generating 3D video streams in cooperation of a server and a client.

FIG. 10 is a flow chart of a client method for generating 3D video streams in cooperation of a server and a client.

FIG. 11 is a flow chart of a process for synthesizing an image using a 3D model of an object.

FIGS. 12a, 12b and 12c illustrate a process for rendering objects with information from images captured by other camera.

FIG. 13 is a flow chart of a process for rendering objects with information from images captured by other camera.

FIGS. 14-La, 14-Lb,14-Lc, 14-Ld depict subsequent images of a rod and a disk, as seen from a left eye.

FIGS. 14-Ra, 14-Rb,14-Rc, 14-Rd depict subsequent images of a rod and a disk as transformed for a right eye view.

FIG. 14e is a flowchart of a process for modifying disparity value distribution of an on-field object.

FIG. 15 illustrates ball detection in two cases.

FIG. 16 is a flow chart of a process for presenting a ball in 3D display.

FIG. 17 is a flow chart of a process for presenting a ball in 3D display using its size.

FIG. 18 is a flow chart of a process for presenting a static object in 3D display.

FIG. 19 is a block diagram of a system for a program feed in which 2D to 3D conversion is followed by switching between cameras.

FIG. 20 is a block diagram of a system for a program feed in which 2D to 3D conversion is performed on a program feed after switching between cameras.

FIG. 21 is a flowchart of a process for generating a 3D display from a program feed.

FIG. 22 is a block diagram of a system for storage and retrieval of camera parameters using a parameter database.

FIG. 23 is a block diagram of a system for storage and retrieval of camera parameters using a scene model database.

FIG. 24 is a block diagram of a system for supporting a client process for local generation of a 3D display.

FIG. 25 is a flow chart of a client process for local generation of a 3D display.

FIGS. 26a, 26b and 26c illustrate generating a 3D display by moving cameras.

FIG. 27 is a flow chart of a process for generating a 3D display by moving cameras.

FIG. 28 is a block diagram of a system for inserting graphics into a stereoscopic video stream.

FIG. 29 depicts positioning of 3D graphics with respect to an object of interest.

FIG. 30 is a flowchart of a process for rendering graphics in the depth of an object.

### DETAILED DESCRIPTION OF THE INVENTION

The present invention will now be described in terms of specific example embodiments. It is to be understood that the invention is not limited to the example embodiments disclosed. It should also be understood that not every feature of the methods and systems handling the described device is necessary to implement the invention as claimed in any particular one of the appended claims. Various elements and features of devices are described to fully enable the invention. It should also be understood that throughout this disclosure, where a method is shown or described, the steps of the method may be performed in any order or simultaneously, unless it is clear from the context that one step depends on another being performed first.

Before explaining several embodiments of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Unless otherwise defined, all technical and scientific terms used herein have the same meaning as commonly understood by one of ordinary skill in the art to which this invention belongs. The systems, methods, and examples provided herein are illustrative only and not intended to be limiting.

In the description and claims of the present application, each of the verbs “comprise”, “include” and “have”, and conjugates thereof, are used to indicate that the object or objects of the verb are not necessarily a complete listing of members, components, elements or parts of the subject or subjects of the verb.

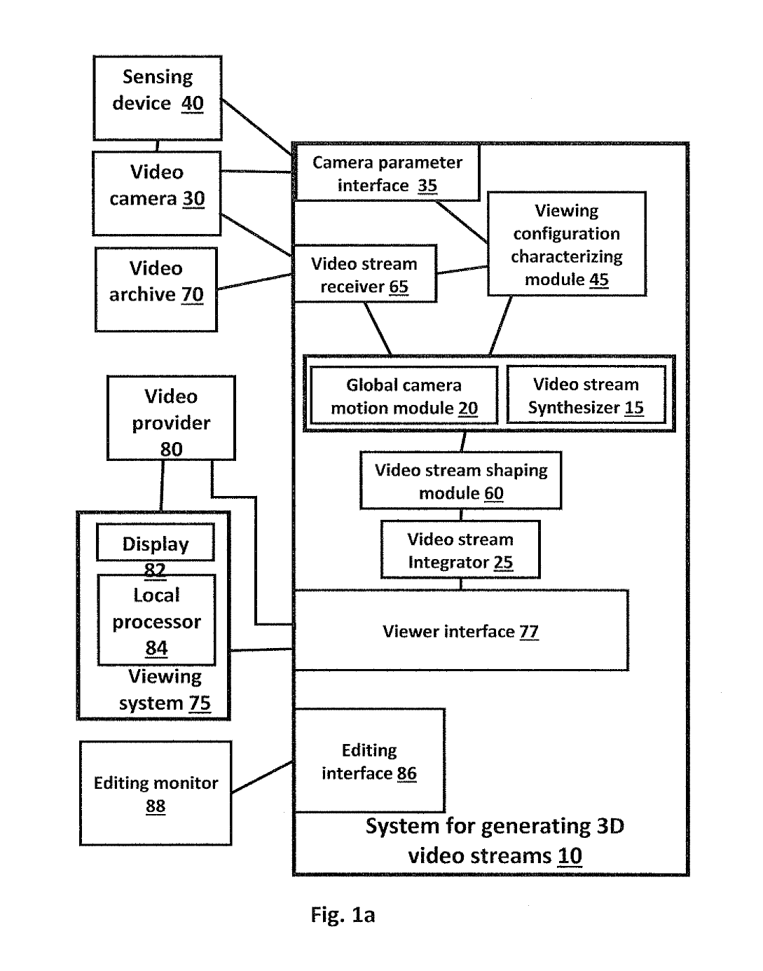

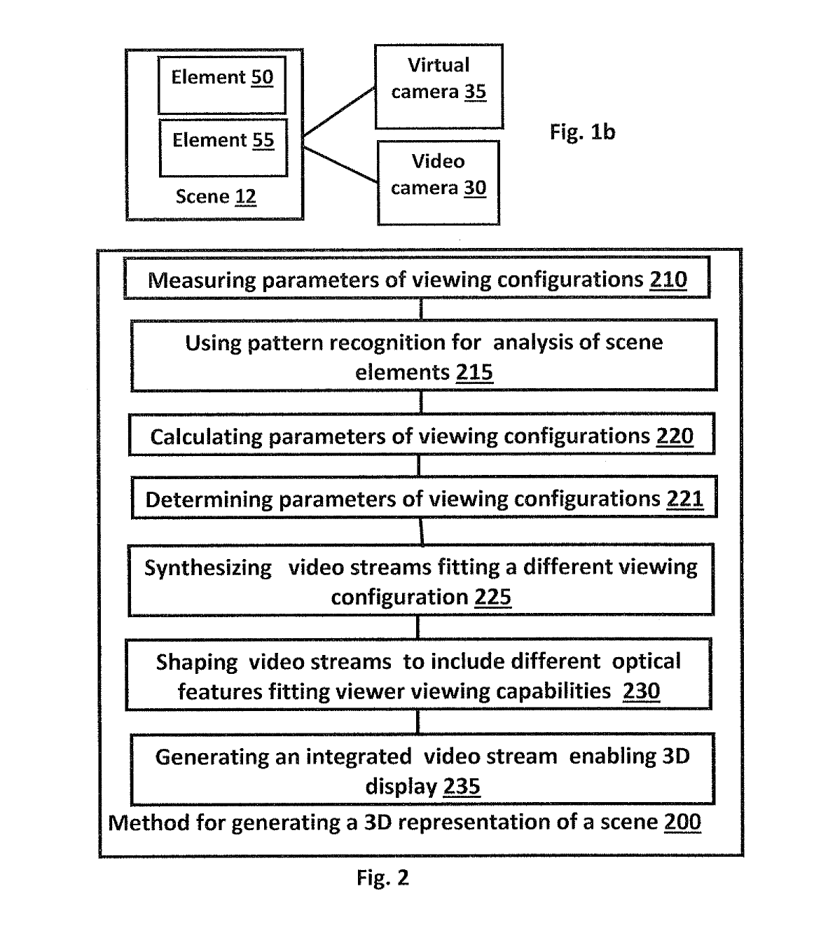

### A System and Method Embodiment for Generating 3D Video Streams (FIGS. 1-2)

It is provided a system 10, as shown in FIG. 1a and FIG. 1b, for generating a 3D representation of a scene 12. System 10 includes a synthesizing module 15, and a video stream integrator 25. Scene 12 is represented by a first video stream captured by a certain camera 30 at a first set of viewing configurations. Synthesizing module 15 provides video streams compatible with capturing scene 12 by a virtual camera 35 of FIG. 1b, having a to respective set of viewing configurations different from the first set of viewing configurations. Video stream integrator 25 generates an integrated video stream enabling three-dimensional display of the scene by integration of two video streams. In one example the two video streams are the first video stream and one provided video streams. In another example, they both are provided video stream having different sets of viewing configurations.

In an example, camera 30 is a fixed camera at a first location and a first viewing direction in relation to a central point at scene 12. Virtual camera 35 is also a fixed camera having a second location at a lateral distance of 30 cm from the first location of camera 30, and having a viewing direction from the second location to the same central point of scene 12, or parallel to the first viewing direction. Thus, the set of viewing configurations of the first video stream includes a viewing configuration which is different from a repeating viewing configuration of the provided video stream, linked to virtual camera 35.

A viewing configuration of camera 30 capturing scene 12 is characterized by parameters like viewing direction relative to earth, geographical location, viewing direction relative to elements of the scene, location relative to elements of the scene, and zooming parameters or lens parameters. Note that viewing direction and location in any reference system may be each represented by three values, xyz for location, for example.

System 10 includes a camera parameter interface 30 for receiving parameters characterizing a viewing configuration of the first camera from devices or sensors 40 relating to camera 30. Exemplary devices are encoders mounted on motion mechanisms of camera 30, potentiometers mounted on motion mechanisms thereof, a global positioning system (GPS) device, or an electronic compass associated with camera 30.

System 10 includes a viewing configuration characterizing module 45 for calculating parameters characterizing a viewing configuration by analysis of elements 50 and 55 of scene 12 as captured by camera 12 in accordance with the first video stream. System 10 includes a video stream shaping module 60 for shaping a video stream for binocular 3D viewing, and video stream receiver 65 for receiving the first video stream from video camera 30 or a video archive 70. In one example, the shaping is effecting spectral content or color of the frame and the viewer has for each eye a different color glass. In other example the shaping is effecting polarization, and the viewer has for each eye a different polarizer glass.

System 10 feeds a client viewing system 75 using a viewer interface 77, which either feeds the client directly or through a video provider 80, a broadcasting utility, for example. Client viewing system has a display 82, a TV set for example, and a local processor 84, which may perform some final processing as detailed below. In one example, the client viewing system is a personal computer or a laptop computer having a screen as display 82 and operating system for local processing. The video provider 80 in such a case may be a website associated with or operated by system 10 or its owner.

For off-line processing of video stream from archive 70, and even for real time processing, a human intervention may be needed from time to time. For this aim, system 10 includes an editing interface 86 linked to an editing monitor 88 operated by a human editor.

A method 200 for generating a three-dimensional representation of a scene 12 is illustrated in the flow chart of FIG. 2. Method 200 includes a step 225 of providing or synthesizing video streams compatible with capturing scene 12 by cameras 40 and 30, and step 235 of generating an integrated video stream enabling three-dimensional display of the scene by integration of two video streams, the first video stream from camera 30 and one of the provided video streams fitting virtual camera 35, for example.

Synthesizing video streams fitting virtual camera 35, may be facilitated by knowing parameters of the set of viewing configuration associated with the first video stream, building a depth map, or other suitable representation such as surface equations, of scene elements 50 and 55, and finally transforming the frames of the first video stream to fit viewing configurations of camera 35. For knowing the viewing configuration parameters, the method includes a step 210 of measuring parameters of the viewing configurations, using sensing device 40. Alternatively, the method includes step 215 of using pattern recognition for analysis of scene elements 50 and 55, and consequently, a step 220 of calculating parameters of the viewing configurations by analysis of the recognized elements. Known geometrical parameters of scene elements 50 and 55 may be used for calculating the viewing configuration parameters. Sometimes, a rough estimate of the element geometrical configuration is sufficient for that calculation. Once the parameters of the viewing configurations associated with the first video stream are known, it is possible to determine in step 221 parameters of a different set of viewing parameters associated with a desired video stream that enable 3D viewing.

The method also includes the step 230 of shaping a video stream, such that upon integrating the shaped video stream with another video stream, and displaying the integrated video stream to a viewer having viewing system 75 and binocular viewing capability, the viewer senses a 3D scene.

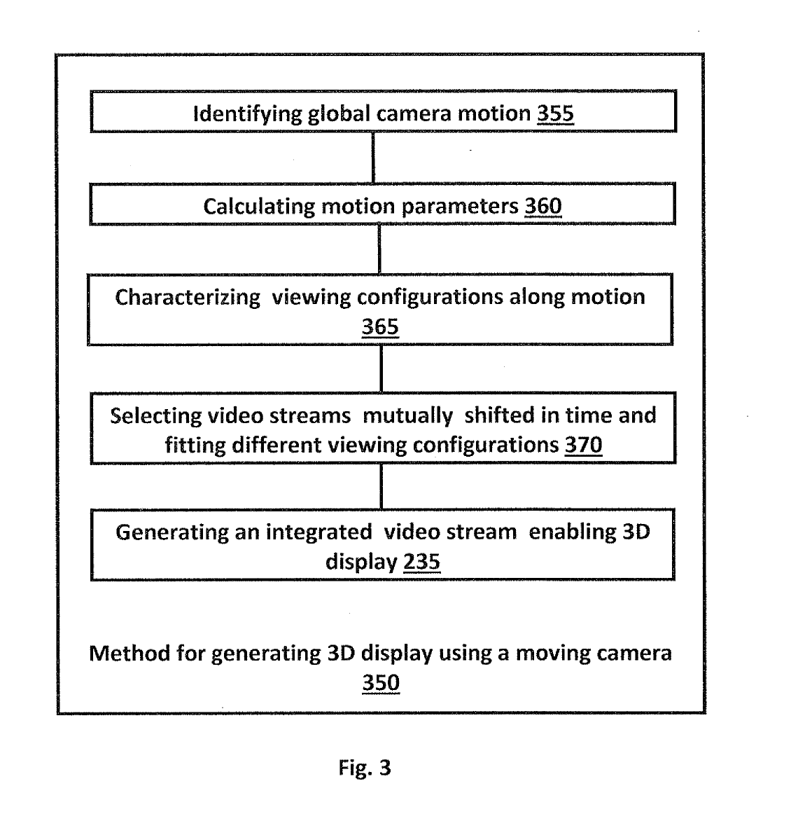

### A Method Embodiment for Generating a 3D Display Using a Moving Camera (FIG. 3)

In a preferred embodiment, real time-shifted frames are used for a stereo view. This method, known in the prior art [ref. 13], is quite effective in sports events as the shooting camera is performing a translational motion during extended periods of time. In system 10 of FIG. 1a, video stream receiver 65 includes a video buffer to store the recent video frames and uses the most convenient one as the stereo pair. The camera motion measured by sensing devices 40 as well as the lens focal length measured by a zoom sensor are used to point at the most “stereo appropriate” past frame at the video storage buffer.

In other words, camera 30 may move for a certain time period in a route such that two frames taken in a certain time difference may be used for generating a 3D perception. For example, suppose that camera 30 is moving along of the field boundary at a velocity of 600 cm/sec, while shooting 30 frames/sec. Thus, there is a location difference of 20 cm and a ( 1/30) sec time difference between each consecutive frames. Taking three frames apart, one gets a 60 cm location difference which is enough for getting 3D perception. The location difference is related to a ( 1/10) sec difference, which is short enough for the stereo image pair to be considered as captured at the same time.

To make use of such camera movements, system 10 includes a global camera motion module 20 as the synthesizing module or as a part thereof. Module 20 identifies in step 355 global camera motion during a certain time period, calculates in step 360 parameters of the motion, and characterizes in step 365 viewing configuration relating to a time within the certain time period. That step is based on characterized viewing configuration relating to another time within the certain time period. Then, in step 370 module 20 selects video streams mutually shifted in time such that the integrated video stream generated in step 235 includes superimposed video streams having different viewing configurations at a time, thus being able to produce 3D illusion.

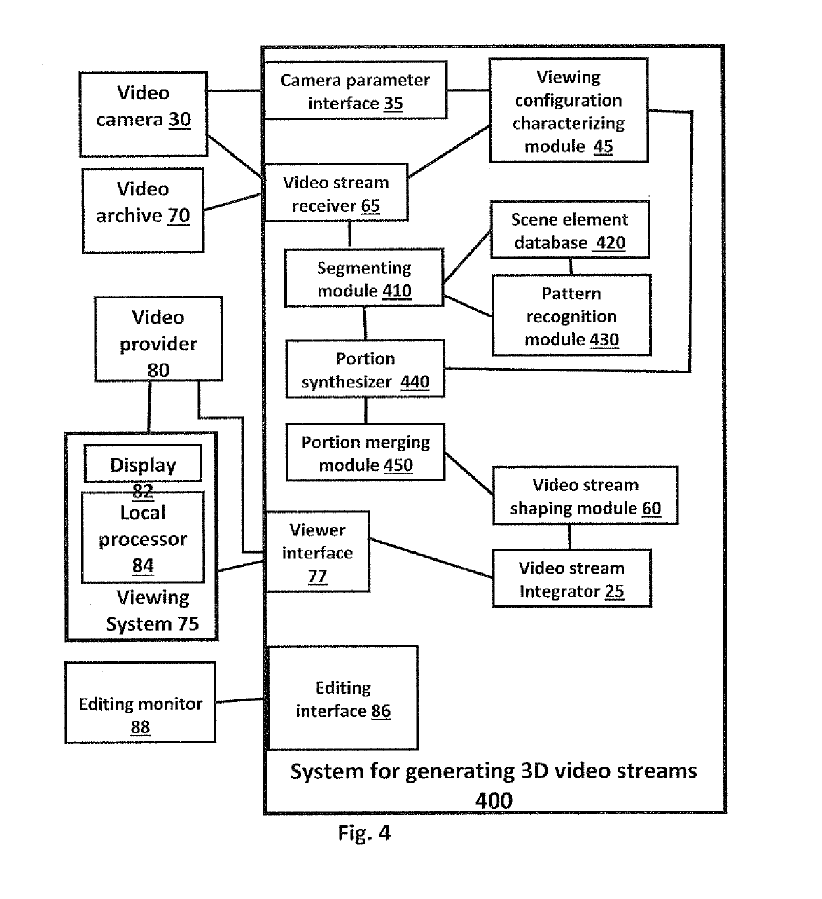

### A Sport Scene Embodiment (FIGS. 4-8)

Reference is now made to FIG. 4 which illustrates a block diagram of a system 400 for generating 3D video streams of a sport event. System 400 includes a segmenting module 410 for segmenting a scene element 50 appearing in a frame from a rest portion of a frame, element 55 for example. Such segmenting is facilitated by chromakeying, lumakeying, or dynamic background subtraction, for example. Additionally, such segmenting is facilitated by detecting field lines and other markings by line detection, arc detection or corner detection.

To facilitate elemental analysis, system 400 includes a scene element database 420 and a pattern recognition module 430 for recognizing a scene element 50 based on data retrieved from scene element database 420, and for calculating viewing configuration parameters in accordance with the recognized element and with the element data.

In a sport event, a sport playing field or its part is included in scene 12, and the field known geometrical parameters may be stored in scene element database 420 and used for calculating viewing configuration parameters. Pattern recognition module 430 is used for recognizing a part of the sport playing field, as further elaborated below.

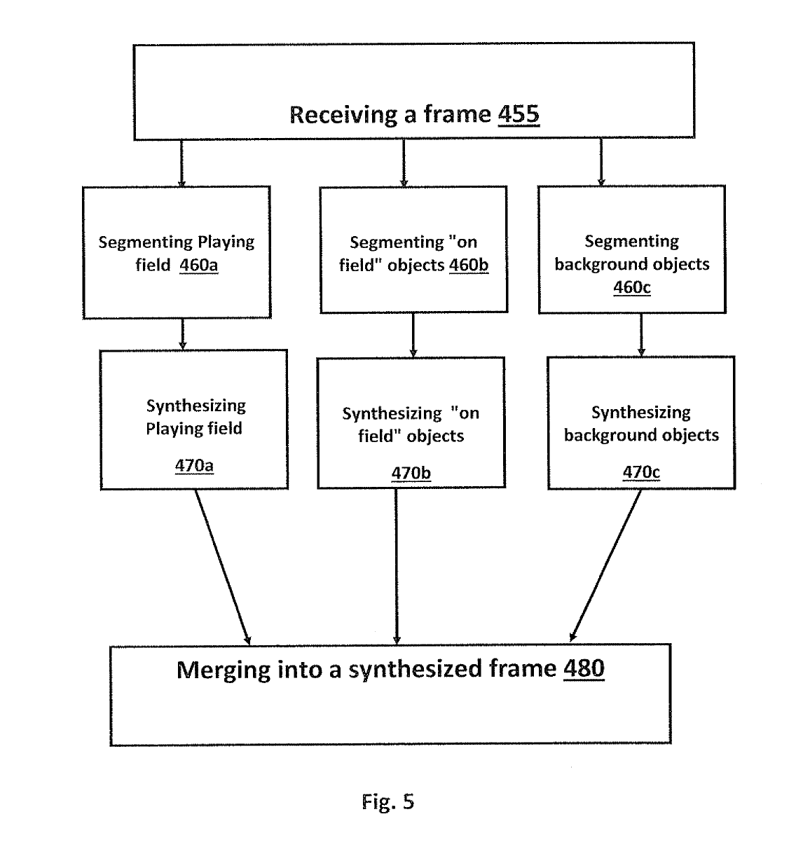

In addition to a playing field, scene 12 also includes on-field objects and background objects. Segmenting module 410 segments a frame to portions including separately the playing field, the on-field objects and the background objects. Consequently, portion synthesizer 440 associates each portion to the different viewing configuration, and portion merging module 450 merges the portions into a single frame, as illustrated in FIG. 5. The process includes a step 455 of receiving a frame, parallel steps 460a, 460b and 460c for segmenting the portions, parallel steps 470a, 470b and 470c for synthesizing appropriate respective portions, and a step 480 of merging the portions into a synthesized frame.

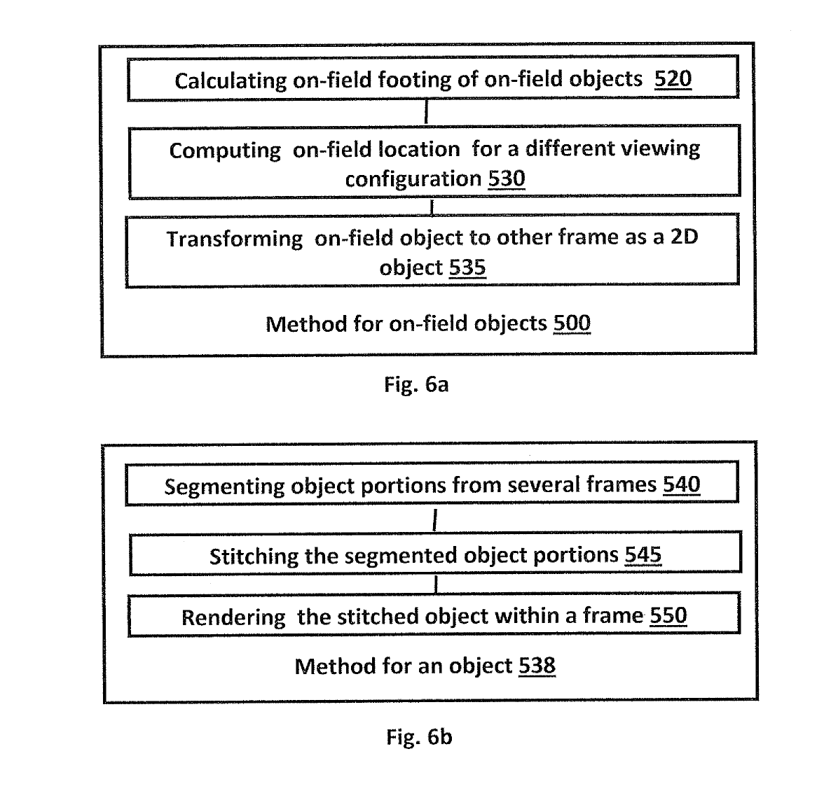

A flow chart of a method 500 for dealing with on-field objects is shown in FIG. 6a. Method 500 includes a step 520 of calculating of on-field footing locations of on-field objects in a certain frame of the first video stream, a step 530 of computing of on-field footing locations of on-field objects in a respective frame associated with a different viewing configuration, and a step 535 of transforming the on-field object from the certain frame to the respective frame as a 2D object. Such a transformation is less demanding than a full 3D transformation of the object.

An improved process for using a model is described below.

Another method 538 to take care of an on-field object is depicted in the flow chart of FIG. 6b. Method 538 includes a step 540 of segmenting several portions of the object from several frames of the first video stream, a step 545 of stitching the portions of the object together to fit a different viewing configuration, and a step 550 of rendering the stitched object within a synthesized frame associated with the different viewing configuration. Such stitching is usually required for creating the virtual camera view since due to stereoscopic parallax, that view exposes object parts that are not visible in the real camera view. As past or future frames of the first video stream may contain these parts, the object must be tracked either backward or forward to capture the missing parts from at least one forward or one backward video frames and to stitch them into one coherent surface.

An improved process of using information from views captured by other cameras is described below.

An improved method for modifying disparity values of on-field objects is described below.

A playing object like a ball may be treated by segmenting it, providing its location with respect to the playing field, and generating a synthesized representation of the playing object for merging into a synthesized frame fitting a different viewing configuration.

An improved process for a playing object is described below.

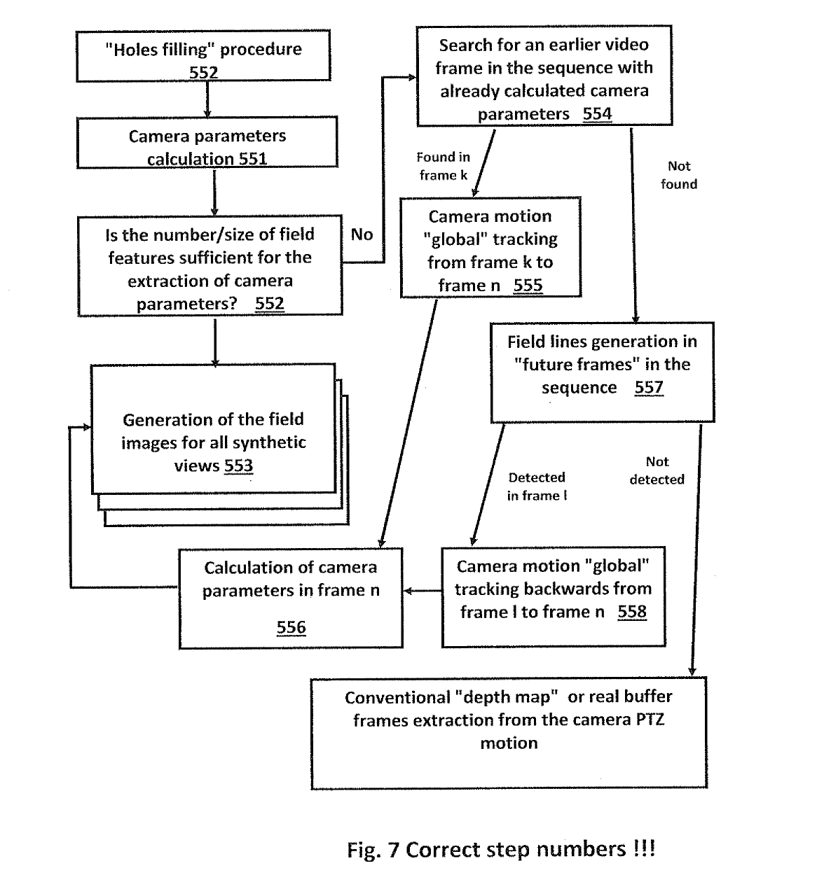

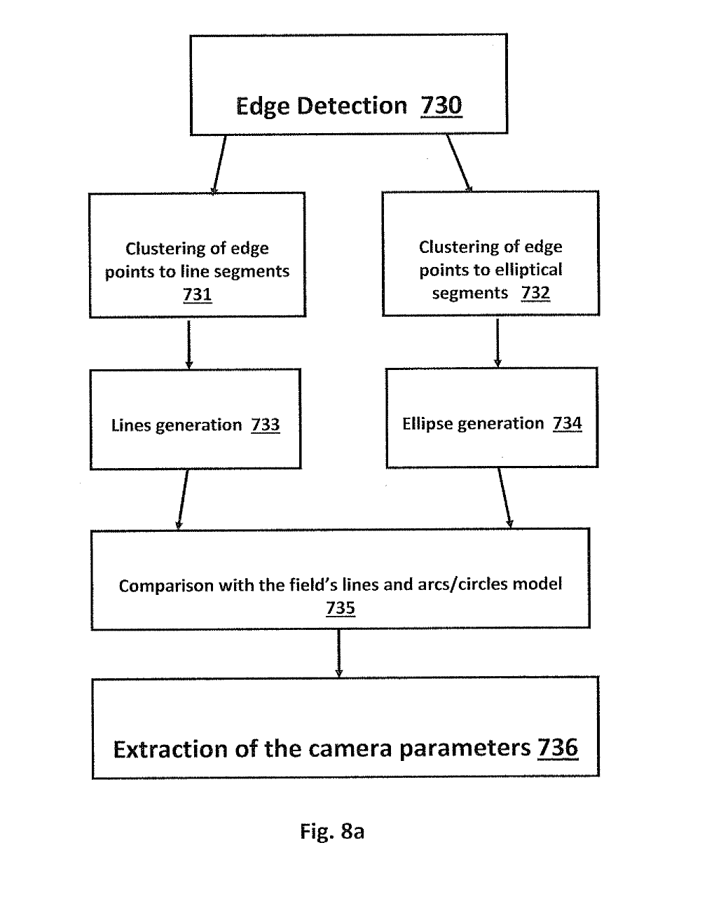

Reference is now made to FIGS. 7-8, dealing with using image processing software to convert a single conventional video stream of sports events into a three dimensional representation. The image processing module may contain some of the modules of system 400 like pattern recognition module 430, segmenting module 410 and portion synthesizer 440. It may be implemented on a personal computer, a processing board with either a DSP (digital signal processing) and/or FPGA (field programmable gate array) components, or on a dedicated gate array chip. The image processing module and may be inserted in any location on the video path, starting with the venue, the television studio, the set-top box or on the client television set 75.

The description of FIG. 7 of refers to a video sequence generated by one camera shooting a sports event, soccer for the sake of illustration. Typically there are multiple cameras deployed at a given venue to cover an event. The venue producer normally selects the camera to go on air. Automatic identification of a new sequence of frames related to a new camera going on air (a “cut” or other transition) has been proposed in the prior art [ref. 5] using global image correlation methods, and system 400 includes such means.

The method proposed in this embodiment, illustrated in FIG. 5, is based on frame segmentation in steps 460a, 460b and 460c into respective three object categories or portions, the playing field, on-field objects and background objects. The on-line objects are players, referees and a ball or other playing object. The remote background objects, typically confined to image regions above the playing field, are mainly balconies and peripheral billboards. Note that the ball may also appear against the background, once it is high enough.

The typical playing field has a dominant color feature, green in soccer matches, and a regular bounding polygon, both being effective for detecting the field area. In such a case, a chromakeying [ref. 6] is normally the preferred segmentation procedure for objects against the field background. In other cases, like ice skating events a lumakey process [ref. 7] may be chosen. In cases that the playing field does not have a dominant color or a uniform light intensity, for areas inside the field that have different colors such as field lines and other field markings, and for background regions outside the field area, other segmentation methods like dynamic background subtraction provide better results.

The partial images associated with the three object categories are separately processed in steps 470a, 470b and 470c to generate the multiple stereo views for each image's component. The image portions for each view are then composed or merged into a unified image in step 480.

FIG. 7 illustrates the processing associated with each object's category. Regarding the playing field, the first step illustrated in FIG. 7 (step 552) is aimed at “filling the holes” generated on the playing field due to the exclusion of the “on-field” objects. This is done for each “hole” by performing “global camera motion” to the frame where this “hole region” is not occluded by a foreground object. The global camera motion can be executed using the well known “block matching method” [ref. 8] or other “feature matching” [ref. 9] or optical flow methods. The “hole content” is then mapped back onto the processed frame.

In the next step, illustrated in FIG. 8a, the camera parameters like pan angle, tilt angle and lens focal length for the processed video frame are extracted. For extracting, searching is made for marking features such as lines and arcs of ellipses on the segmented field portion of the frame. The parameters of the shooting camera are then approximated by matching the features to a soccer field model. The first step, 730 in FIG. 8a, is edge detection [ref. 10], or identifying pixels that have considerable contrast with the background and are aligned in a certain direction. A clustering algorithm using standard connectivity logics is then used, as illustrated in steps 731 and 732 in FIG. 8a, to generate either line or elliptical arc segments corresponding to the field lines, mid-circle or penalty arcs of the soccer field model. The segments are then combined, in steps 733 and 734, to generate longer lines and more complete arcs of ellipses.

The generated frame's lines and arcs, 860 in FIG. 8b, are then compared to the soccer field model 855 to generate the camera parameters, pan angle, tilt angle and focal length as illustrated in steps 735 and 736 of FIG. 8a. The algorithm for conversion of detected lines/arcs to the field model to extract the camera parameters, including the pre game camera calibration, is known in the prior art and is described for example in ref. 11.

The camera parameters are then reciprocally used to generate, in step 553, synthetic field images of each requested view required for the 3D viewing, wherein a new camera location and pose (viewing configuration) are specified, keeping the same focal length.

Sometimes, either the number or the size of the field features (lines, arcs) detected in the processed frames is not sufficient to solve the set of equations specified by the above algorithm. To provide a solution for such cases, a process is used as illustrated in FIG. 7. In step 554, a prior frame k having sufficient field features for the extraction of the camera parameters is searched for in the same video sequence. These extracted parameters are already stored in system 400. The next step, step 555 of FIG. 7, is global tracking of the camera motion from frame k to current frame n. This global image tracking is using either the well known “block matching” method or potential other appropriate methods like feature matching or optical flow techniques [ref. 12]. The camera parameters for frame n are then calculated in step 556 based on the cumulative tracking transformation and the camera parameters of frame k.

In the case that no such earlier frame k has been found, system 400 executes a forward looking search as illustrated in steps 557, 558 and 556 of FIG. 7. Forward looking search is possible not only in post production but also in live situations where the 2D to 3D conversion is done on-line in real time. A small constant delay is typically allowed between event time and display time, affording a “future buffer” of frames. The future processing is identical to the processing of frame n as described in FIGS. 7 and 8a, and the global camera tracking is now executed from the “future frame” l wherein camera parameters were successfully extracted backwards to current frame n.

For convenience or for saving computing time, the past or future frames may be used even if the number and size of the field features is sufficient for successful model comparison and calculation of the camera parameters.

Regarding on-field objects, to know the positions of the players/referees on the field system 400 detects the footing points of the players/referees and projects them onto the model field in the global coordinate system. For each required synthetic view, the camera location and pose are calculated and the players/referees footing points are back projected into this “virtual camera” view. A direct transformation from the real camera's coordinate system to the synthetic camera's coordinate system is also possible. The players are approximated as being flat 2D objects, vertically positioned on the playing field and their texture is thus mapped into the synthetic camera view using a perspective transformation. Perspective mapping of planar surfaces and their textures are known in prior art and are also supported by a number of graphics libraries and graphics processing units (CPUs).

In the case that not even a single frame with sufficient field features has been found in either the past or the future searches, other 2D to 3D conversion methods known in the art [refs. 3,4] are used. In special, use may be made of techniques based on global camera motion extraction to generate depth maps, and consequently either choosing real, time-shifted frames as stereo pairs or creating synthetic views based on depth map.

For a sports scene embodiment, specific relations between scene elements may be used for calculating the viewing configuration parameters. For example, it may be assumed that referees and even players are vertical to the playing field, balconies are at a slope of 30° relative to playing field, and billboards are vertical to the playing field. Similarly, an estimated height of a scene element may be used for calculating the viewing configuration parameters. Relevant scene elements are players, billboards and balconies.

In one specific embodiment, the respective sizes of players at different depths are used to obtain a functional approximation to the depth, and as stereo disparity is linearly dependent upon object depth, such functional approximation is readily converted into a functional approximation of disparity.

The latter case suggests a simplified method of synthesizing the second view, in which surface disparity values are obtained directly from the functional approximation described above. The functional approximation depends on 2D measurements of the real image location and other properties (such as real image height).

To support a significant depth perception by the virtual, view, on-field objects must be transformed differently than the field itself or other backgrounds such as the balconies. Also, objects positioned in different depths are transformed differently which may create “holes” or missing parts in other objects. According to one embodiment, the system stitches objects' portions being exposed in one frame to others visible in other frames. This is done by means of inter-frame block matching or optical flow methods. When a considerable portion of the object's 3D model is constructed it may be rendered for each synthetic view to generate more accurate on field objects views.

To estimate the ball position in each synthetic stereo view, system 400 first estimates the ball position in a 3D space. This is done by estimating the 3D trajectory of the ball as lying on a plane vertical to ground between two extreme “on-field” positions. The ball image is then back projected from the 3D space to the synthetic camera view at each respective frame.

Finally, regarding background objects, the balconies and billboards are typically positioned on the upper portion of the image and according to one embodiment are treated as a single remote 2D object. Their real view is mapped onto the synthetic cameras' views under these assumptions.

Alternatively, the off-field portions of the background can be associated with a 3D model which comprises two or more surfaces, that describes the venue's layout outside the playing field. The 3D model may be based on actual structural data of the arena.

An improved process for static objects is described below.

In another preferred embodiment of the current invention, pan, tilt and zoom sensors mounted on the shooting cameras are used to measure the pan and tilt angles as well as the camera's focal length in real time. In certain venues such sensors are already mounted on the shooting cameras for the sake of the insertion of “field attached” graphical enhancements and virtual advertisements [ref. 13]. The types of sensors used are potentiometers and encoders. When such sensors are installed on a camera there is no need to detect field features and compare them with the field model since the pan, tilt and zoom parameters are available. All other processes are similar to the ones described above.

In a preferred embodiment, real time-shifted frame is used as a stereo view, as mentioned above in reference to FIG. 3. This method, known in the prior art [ref. 13], is quite effective in sports events as the shooting camera is performing a translational motion during extended periods of time. The system of this embodiment comprises a video buffer to store the recent video frames and uses the appropriate stored frames as stereo pairs. For example, the motion sensor's output as well as the lens focal length may be used to point at the most “stereo appropriate” past frame at the video storage buffer.

Another preferred embodiment uses the same field lines/arcs analysis and/or global tracking as described in reference to FIGS. 7-8 to choose the most “stereo appropriate” frame to be used as the stereo pair of the current processed frame.

An improved process for a program feed is described below.

A camera view can also contain no field lines at all (like close-up cameras) and then the proper algorithm based on segmentation alone is chosen.

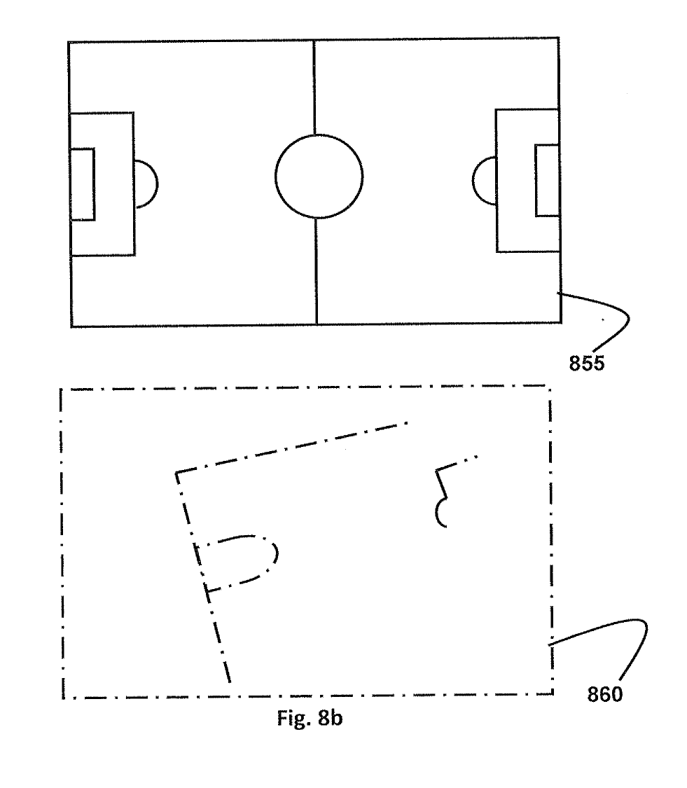

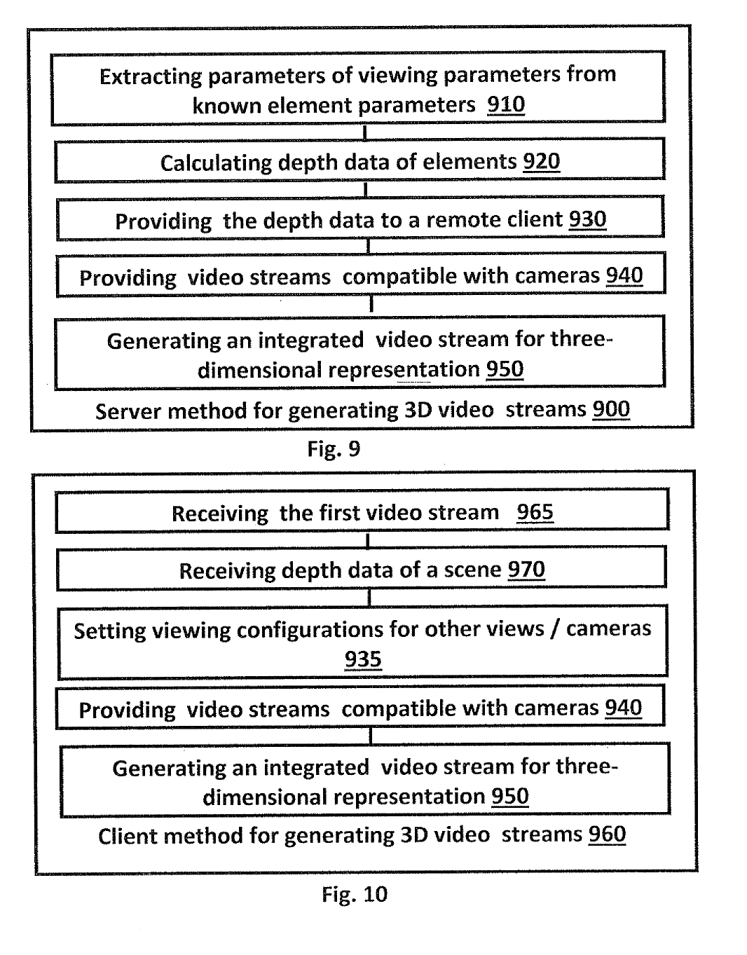

### A Method for Generating 3D Video Streams in Server-Client Cooperation (FIG. 9-10)

Rather than client getting a final integrated video stream, it is possible that part of the preparation of the final integrated video stream is done in the client viewing system 75 of FIG. 1a, using a local processor 84. Referring now to FIG. 9, a method 900 for generating a three-dimensional representation of a scene 12 is described by a flow chart. Scene 12 includes an element having known spatial parameters. Method 900 includes a step 910 of extracting parameters of the first set of viewing configurations using the known spatial parameters, and a step 9200f calculating depth data relating to the scene elements based on the first video stream, and based on the extracted parameters. Then, the method includes the step 930 of providing the depth data to a remote client, who uses that data for providing, in step 940, video streams compatible with capturing the scene by cameras, and generates, in step 950, an integrated video stream enabling three-dimensional display of the scene by integration of two video streams having mutually different sets of viewing configurations.

The depth data may be transmitted in image form, wherein each pixel of the real image is augmented with a depth value, relative to the real image viewing configuration. In another embodiment, the depth information is conveyed in surface form, representing each scene element such as the playing field, the players, the referees, the billboards, etc. by surfaces such as planes. Such representation allows extending the surface information beyond the portions visible in the first image, by a stitching process as described above, thereby supporting viewing configurations designed to enhance the stereoscopic effect.

A client method 960, as described by the flow chart of FIG. 10, includes step 965 of receiving the first video stream, a step 970 receiving the intermediate set of data relating to the scene, a step 935 of setting viewing configurations for other views/cameras, a step 940 of using the intermediate set of data for providing video streams compatible with capturing the scene by cameras, and step 950 of generating an integrated video stream enabling three-dimensional display of the scene by integration of video streams.

Note that according to step 935, the remote client may determine the surface of zero parallax of the 3D images such that the 3D image appears wherever desired, behind a screen, nearby to the screen or close to a viewer. This determination is accomplished by deciding on the distance between the real camera and virtual camera and on their viewing directions relative to scene 12, as known in the art. Step 935 may also be executed implicitly by multiplying the views' disparity values by a constant, or a similar adjustment. A major advantage of such embodiment is that the viewer may determine the nature and magnitude of the 3D effect as not all viewers perceive 3D in the same manner. In one embodiment, the distance between the cameras, and the plane of zero parallax are both controlled by means of an on-screen menu and a remote control.

The invention can be applied to more than one captured video stream, for the purpose of generating multiple additional views as required by auto-stereoscopic displays. In that case, stereoscopic vision techniques for depth reconstruction, as known in prior art, may be used to provide depth values that complement or replace all or part of the depth values computed according to the present invention. In another specific example, the invention may be used to correct or enhance the stereoscopic effect as captured by more than one video stream, as described above: change the surface of zero parallax, the distance between the cameras, or other parameters.

An improved client process is described below. Also, an improved process for moving cameras is described below.

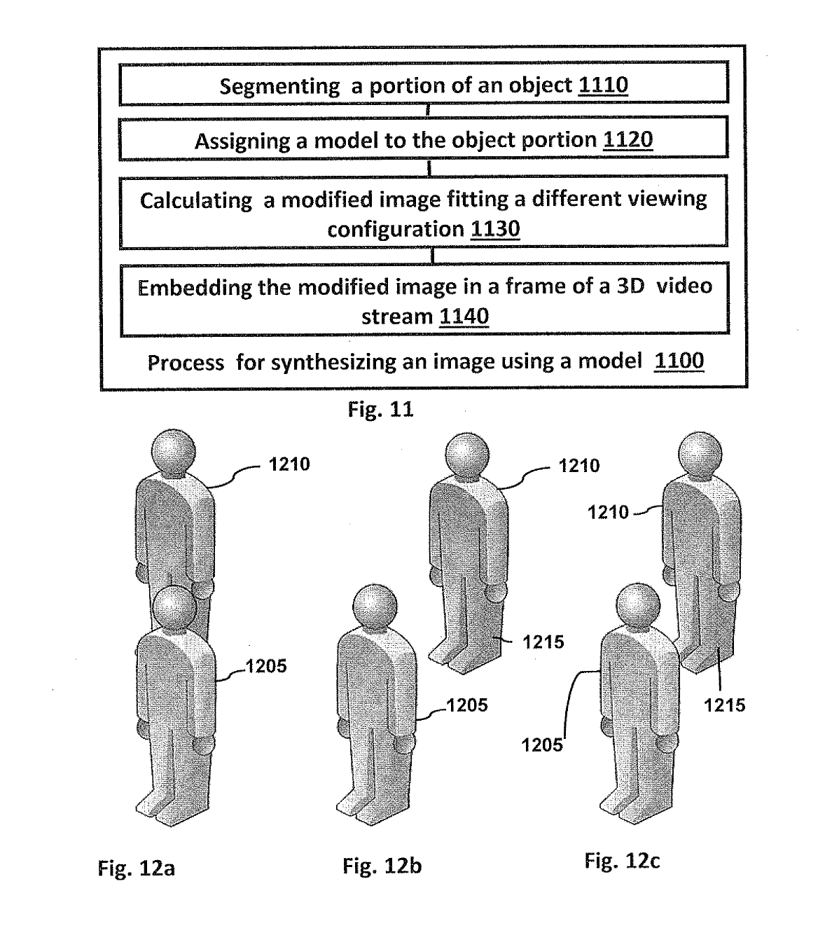

A Process for Transforming on-Field Objects Using Models (FIG. 11)

When the separation between the real camera and the virtual camera increases, the transformed on-field 2D objects might be viewed as planar “cardboard”-like figures. To improve the realism of the computed view, on-field objects are transformed as 3D objects, by assigning non-planar depth values to objects' image points. As these depth values are not available from a single view, use is made of certain models to obtain such values. According to one embodiment, these image points are assigned to a simple geometric object such as an elongated body having a uniform elliptical cross-section. As a single cylinder may not represent a moving figure well, a 3D human shape model may be used as known in the prior art. Thus, several generalized cylinders are assigned to the 2D human image based on segmentation of said human image to body parts. For example, a different cylinder is attached to each hand and foot. Thus, a whole 3D model rather than a single plane is attached to a 2D on-field object image. That model is transformed to the virtual camera coordinate system and is rendered using known computer graphics techniques. To facilitate rendering, the 3D shape model can be represented as a collection of simpler surface patches such as triangles.

An appropriate process 1100 is outlined in the flowchart of FIG. 11, where process 1100 includes a step 1110 of segmenting the portion of the object from the frame, a step 1120 of assigning a 3D model to the portion of the object, in accordance with the 3D model, a step 1130 of calculating a modified image of the portion of the object from a viewing configuration different from the first viewing configuration, and a step 1140 of embedding the modified image in a frame of an integrated video stream enabling 3D display of the scene.

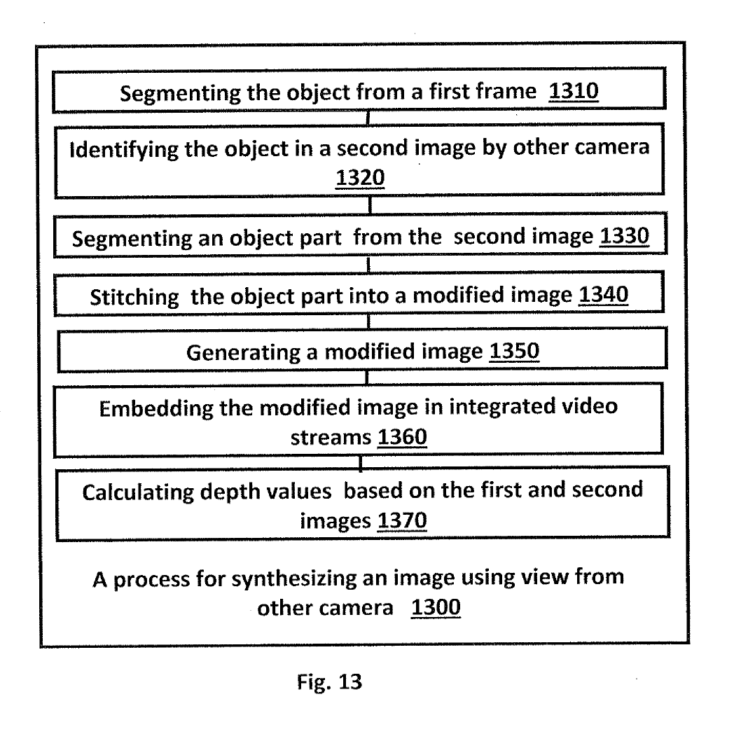

A Process for Rendering Objects with Information from Other Views (FIGS. 12-13)

Instead of stitching object portions from past or previous frames, use may be made of other cameras positioned in the field that provide scene views from different perspectives. Thus, object portions invisible in a first view, may be visible in a second view. As multiple cameras track the action in the game continuously, these time-synchronized multiple perspectives are actually available.

FIG. 12a and FIG. 12c show respectively a single camera view and a desired virtual camera view, both showing a person 1210 standing behind a person 1205. A left leg 1215 of person 1210, for example, is desired for rendering the virtual camera view of FIG. 12c, but is not visible in the camera view of FIG. 12a. However, left leg 1215 is visible in the image of FIG. 12b, captured at the same time by another camera. Thus, missing leg 1215 may be segmented from FIG. 12b and stitched into the virtual camera view of FIG. 12c to obtain the desired effect.

According to one embodiment, stitching from other views requires matching on-field objects between such views. Such matching can be readily computed from footing locations of the objects. As such footing location is available in world coordinate system, such as the playing field coordinate system, object images that correspond to same footing locations, belong to the same object, player or person Now, when occlusion as depicted in the image of FIG. 12a is detected by tracking the players, as described below, a search is conducted in other cameras views to find a view in which these objects are separated, as in the image of FIG. 12c. In such a case it is easier to separate the players and render this specific portion of the virtual image of FIG. 12c from the image of FIG. 12b, compared to rendering from the image of FIG. 12a only. Handling the on-field object as 3D objects as described above, may be preferred in order to prevent a “cardboard” look for the transformed objects.

According to another embodiment, capturing the scene from other viewing locations provides 3D information for objects parts visible in two or more views. Prior art methods of stereoscopic vision detect and match points or curves on the object images in the two or more views. Using the computed camera configurations extracts the depth values for the matched points or curves, thereby creating a 3D object map that assists in realistic rendering of the object.

Reference is now made to FIG. 13, showing a flow chart of a process 1300 for synthesizing an image of an object from a first image of the object, whereas the first image is a part of a frame captured by a first camera at a first viewing configuration. Process 1300 includes a step 1310 of segmenting the object from a rest portion of the frame to get a first segmented image of the object, a step 1320 of identifying the object in a second image captured by a second camera at a second viewing configuration, a step 1350 of generating a modified image of the object in accordance with the first segmented image of the object and the second image, and a step 1360 of embedding or rendering the modified image in a frame of an integrated video stream enabling 3D display of the scene.

In some embodiments, the process includes a step 1330 of segmenting a part of the object from a rest portion of the second image, and a step 1340 of stitching that part into a modified image of the object.

In some embodiments, the captured scene is a sport scene which includes a playing field, on-field objects and background objects. Preferably, the object is a portion of the playing field, a player, or a background object.

In some embodiments, the process includes a step 1370 of calculating a plurality of depth values based on the first image and the second image, and a step 1350 of generating a modified image of the object in accordance with the plurality of depth values.

In some embodiments, the process includes, based on footing location of the object, a step 1310 of segmenting the object from a rest portion of a frame to get a first segmented image of the object.

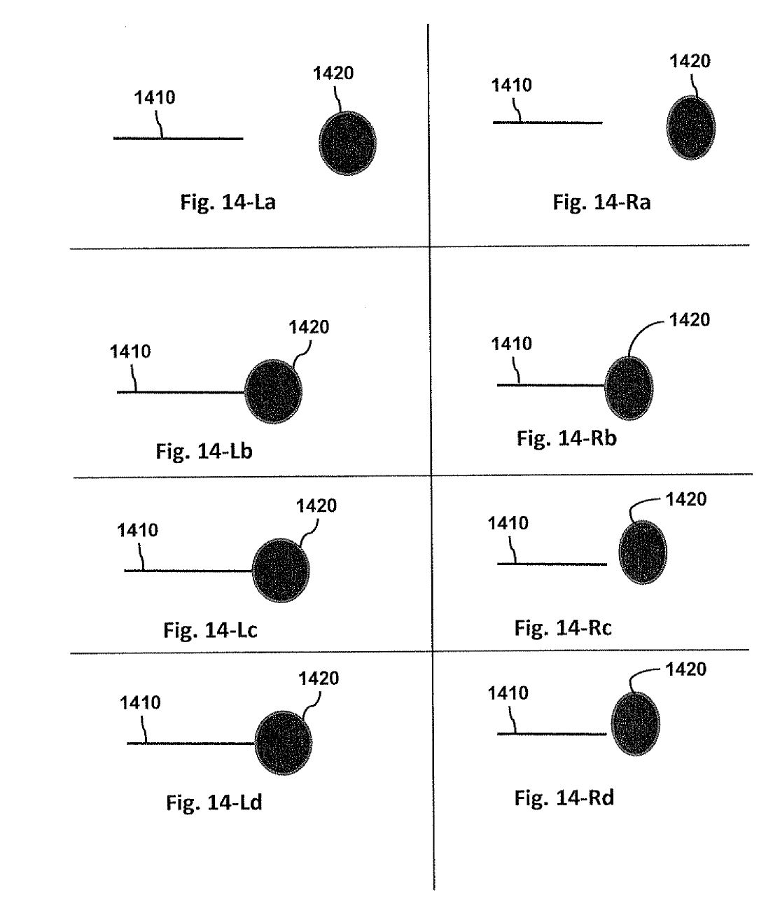

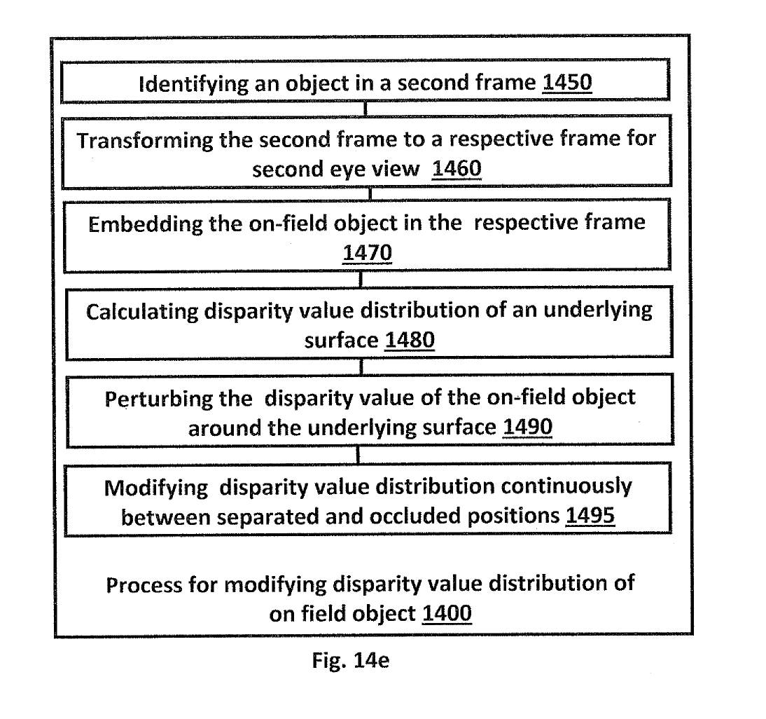

Process for Modifying Disparity Values (FIGS. 14-La-d, 14-R-a-d, 14e)

Disparity value is the shift of an object between scene images as seen from two eyes. Thus, it is closely related to the pixel location of the object in frames used for presenting a 3D display to the two eyes in stereoscopy. As an object is usually not a point, disparity value distribution over all the object defines its location in a frame better than a single disparity value.

Before presenting a process 1400 for modifying disparity vale distribution of an on-field object, reference is made to FIGS. 14-La-d, 14-R-a-d which schematically describe process 1400. FIGS. 14-La and 14-Lb are subsequent frames of a rod 1410 and a disk 1420 captured with a time delay, whereas in FIG. 14-La the two objects are separated and in FIG. 14-Lb the rod and disk touch each other. For the sake of 3D display, the two frames are taken for the left eye, while for the right eye the frames of FIGS. 14-La and 14-Lb are transformed to respective frames 14-Ra and 14-Rb, where the rod is slightly shorter, and the disk is seen slightly elliptical. In other words, each respective frame for the right eye is a result of an appropriate transformation of a frame captured for the left eye. A 3D display is experienced by a viewer either by looking at FIG. 14-La together with FIG. 14-Ra, or by looking at FIGS. 14-Lb and 14-Rb.

For some reason, for example for giving rod 1410 and disk 1420 different depth values, one may modify the location or disparity value of disk 1420 in FIG. 14-Rb such as to be seen separated from rod 1410, to get FIG. 14-Rc. Yet, FIGS. 14-Lc, and 14-Rc also fit two eye stereoscopy, where FIG. 14-Lc is the same as FIG. 14-Lb.

Also, an intermediate modification may be made to the disparity value of disk 1420 such as to bring it closer to rod 1410 but still not touching. Thus, the frame of FIG. 14-Rb may be replaced by three consequent frames presented in FIGS. 14-Rc, 14-Rd and 14-Rb, which continuously modify the disparity value from a first position to second position.

Referring now to realistic events occurring in sports scene, as players are non-rigid, moving objects, stitching solution may apply only to certain cases where the current object shape can be reliably predicted from forward or backward video frames. Dealing with an occluded object, the shape of the occluded object, or its portion that undergoes occlusion, is relatively static through the occlusion time frame, as can be verified by comparing the object's shape before and after the occlusion.

In other cases, segmenting the objects or predicting their respective shape during occlusion cannot be reliably performed, potentially resulting in visual artifacts. Such cases are characterized by significant occlusions, high objects' dynamics, multiple interacting objects or a combination of these factors.

Even when stitching from other views as depicted in FIG. 12a-c, the required portions may be occluded by another objects or otherwise unavailable. In such a case, it may be preferable to modify the computed disparity values for the object in a way that would minimize visual artifacts. In one specific embodiment, the disparity shall be set to the computed disparity of the underlying surface. In another embodiment, the disparity shall be set to the computed disparity of the underlying surface, and perturbed by a small differential disparity value to visually separate the surfaces by means of “micro-stereopsis”. In yet another embodiment, the computed disparity is modified to change continuously across the boundary between the visually joined objects.

As the change of object disparity, from the value computed according to its footing location to the value of the playing field or another modified value, may be abrupt and hence visually noticeable, it may be necessary to temporally smooth that transition as follows. First, isolated players are segmented and identified as such based on size and shape characteristics such as aspect ratio. Then, isolated players are tracked from frame to frame as known in prior art, maintaining a unique tracking ID (identification) for each tracked player. Tracking is using estimates of present object's location, velocity and acceleration to predict its location in subsequent frames. When the object is detected in said subsequent frames based on such prediction, the above mentioned estimates are updated. When multiple players interactive closely, similarity measures such as color, shape or structure correlation may be used to facilitate tracking.

Occlusion situations where two or more players merge into a single segment are detected by track collision and also by change in size and shape. When occlusion is detected, the disparity values are changed to modified disparity values as described above, during the occlusion duration. In order to temporally smooth the transition between footing-based values to modified disparity values, within a smoothing duration of T frames, the disparity values of the isolated players are adjusted for the last T frames of isolation as follows:

D_{adjusted}=(D_{modified}*t+D_{isolated}*(T−t))/T

A delay value of T is used to ensure that the information required to adjust the disparity of an occluded player is available at the time of adjustment.

Similarly, when a player breaks from an occlusion situation and becomes isolated again, the associated disparity is adjusted back from the modified value to the isolated value with temporal smoothing as described above.

Referring now to FIG. 14e, a process 1400 for synthesizing an image of a on-field object captured in several frames by a certain camera at a first set of viewing configuration of a sports scene is presented. The on-field object is identified in a first certain frame. The process includes a step 1450 of identifying the on-field object in a second certain frame, a step 1460 of transforming a portion of the second frame to a respective frame associated with a different set of viewing configuration, and a step 1470 of embedding the on-field object in the respective frame such that the second certain frame of the two or more frames and the respective frame fitting two eye stereoscopy. The first viewing configuration and the different set of viewing configurations being suitable for two eye stereoscopy.

In some embodiments, the process includes a step 1480 of calculating a disparity value distribution of a surface underlying the on-field object. The disparity value distribution of the embedded on-field object is determined in accordance with the calculated disparity value distribution of the underlying surface. Preferably, the disparity value distribution of the embedded the on-field object is perturbed in step 1490 in a series of frames having the different set of viewing configurations around a calculated disparity value distribution of the underlying surface. The perturbations are by a small differential disparity value such as to visually separate the first object from the underlying surface. Preferably, the disparity value distribution of the embedded on-field object is modified continuously in step 1495 between a frame having separated on-field objects and a frame where the on-field objects are not separated.

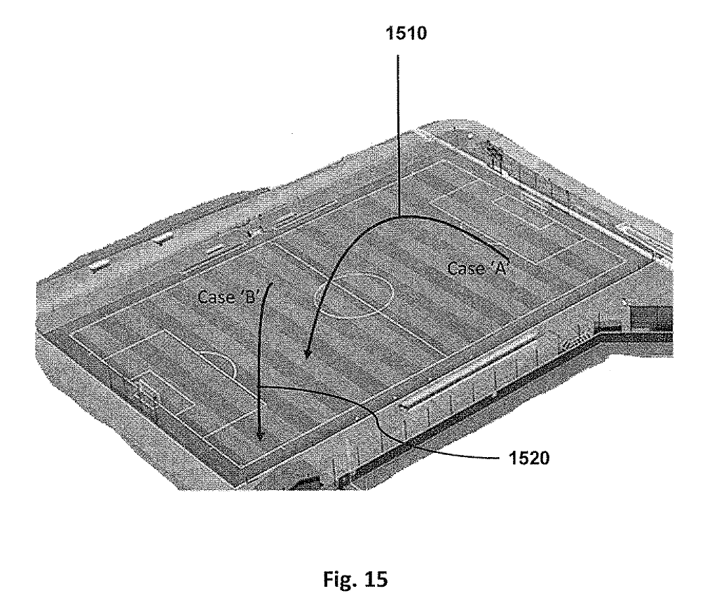

### A Process for Transforming a Flying Ball (FIGS. 15-17)

A ball stands here for any playing object, as played with in a specific sports activity. Ball detection is effected by color-based detection, shape based detection or motion-based detection. The ball has specific colors, usually one or two distinct, high-contrast colors that are selected to enhance its visibility for the players and the audience, against a common arena background. For example, the ball may be orange colored, yellow-colored, or a combination of two high-contrast colors such as black and yellow or blue and white. These colors may be known in advanced, manually entered in a setup process or designated by the operator in an image captured at the beginning of the game.

Color-based detection may be effected, by creating a color distance image in which every pixel is assigned a distance measure from the pre-defined ball color. When the ball has two colors, for example, the least distance value from the ball's color is used as a distance measure. In such a color distance image, a ball appears as a compact ball sized dark region.

Now a second criterion can be applied for ball detection, by scanning the color distance image for compact ball-sized dark regions. If the expected ball size is known, a morphological filter such as opening-subtract with a suitable structuring element may be used to detect the ball. If the expected size is not known, multiple-sized filters may be used, or alternatively, a single filter is executed against a multi-resolution image representation.

The color and size criteria may not be sufficient for robust detection, as there may be spots in the arena which has similar compact shapes of same color. To improve ball detection rate and reduce false detection rate, a third criterion may be applied for ball detection, in order to cause ignorance of static ball-like objects. For To this aim, moving ball detection may be applied as known in prior art, and consequently color or shape detection may be applied as described above. Alternatively, ball candidates are detected in a single image by color or shape, and then static ball-like structures are eliminated based on their occurrence in the same location in the image sequence. In addition, moving ball-like objects may be eliminated based on speed constraints, as slow objects are probably not flying balls, while very fast objects can be ignored as their stereoscopic effect may not be perceived by the viewer's eye.

Given a moving ball, determining its 3D location is desired in order to compute the correct disparity value for creating a desired 3D effect. FIG. 15 includes a Case ‘A’ in of an air trajectory 1510 where end-points of the air trajectory are detected. Each such end point is associated with a point in 3D space, based on the field surface equations. For many practical applications one may assume that the ball travels in a plane perpendicular to the field surface, as dictated by the downward direction of gravity, whenever there is no strong wind effect. Thus, each image location of the traveling ball can be readily converted to 3D coordinates by computing its space location on that perpendicular plane. Each 3D trajectory point is readily transformed to the other viewing configuration in order to determine the disparity value.

The embodiment described above is less effective when the ball is travelling towards the camera, as depicted in Case ‘B’ by air trajectory 1520. In another situation, the visible endpoints of the ball's trajectory do not all lie on the field surface. In these cases, the size of the ball image is used to compute the distance of the ball from the camera. Given the nominal ball size, that distance is measured and the ball is positioned in 3D space, along a line computed from the back-projection of the ball's image center, at the computed distance. Due to the small size of the ball, the estimate of that distance from a single image is error prone, as small size measurement errors translate to large distance errors. Additionally, motion blur may increase the ball size significantly. To overcome those errors, use is made of a sequence of images to increase the ball size measurement accuracy and hence the accuracy of ball distances. In addition, ball size is measured perpendicular to the image motion vector, hence reducing errors due to motion blur.

Ball size measurements may be smoothed in time, taking into account the monotonous change in ball size, increasing when moving towards the camera, decreasing when moving away from the camera. A smoothing filter such as a Median filter is very effective in the case of monotonous signals/sequences.

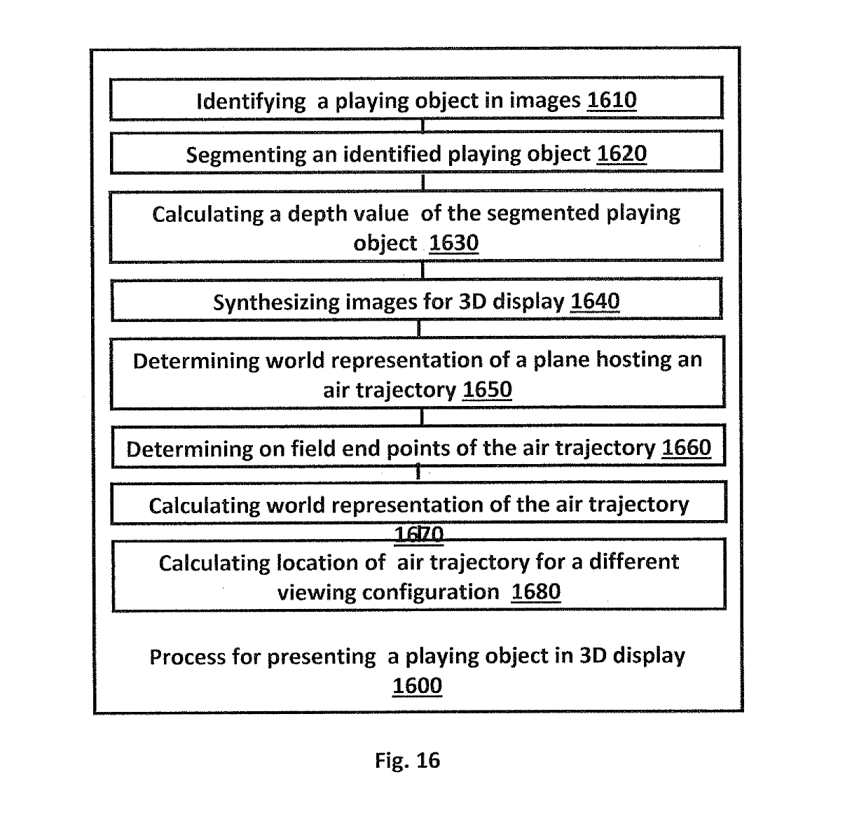

Reference is now made to FIG. 16, depicting a flow chart of a process 1600 for presenting a playing object in 3D display. Process 1600 includes a step 1610 of identifying the playing object in the first series of images to get identified playing objects in respective images, a step 1620 of segmenting an identified playing object from the rest of a respective image, a step 1630 of calculating depth values associated with the segmented playing object, and a step 1640 of synthesizing a second series of images of the playing object fitting a second set of viewing configurations. For the synthesis, use is made for each image of the second series, of the respective calculated depth values.

In some embodiments, process 1600 includes transforming a first representation of an air trajectory of the playing object as captured in the first series of images to a second representation of the air trajectory in accordance with the second set of the viewing configurations. For that sake the process preferably includes, based on the first representation of the air trajectory, a step 1650 of determining world representation of a plane disposed vertical to an horizontal plane and hosting the air trajectory, a step 1670 of calculating world representation of the air trajectory, and a step 1680 of calculating disparity values along the air trajectory in accordance with the second set of viewing configurations based on the calculated world representation of the air trajectory. Preferably, the process includes a step 1660 of determining on-field endpoints of the air trajectory.

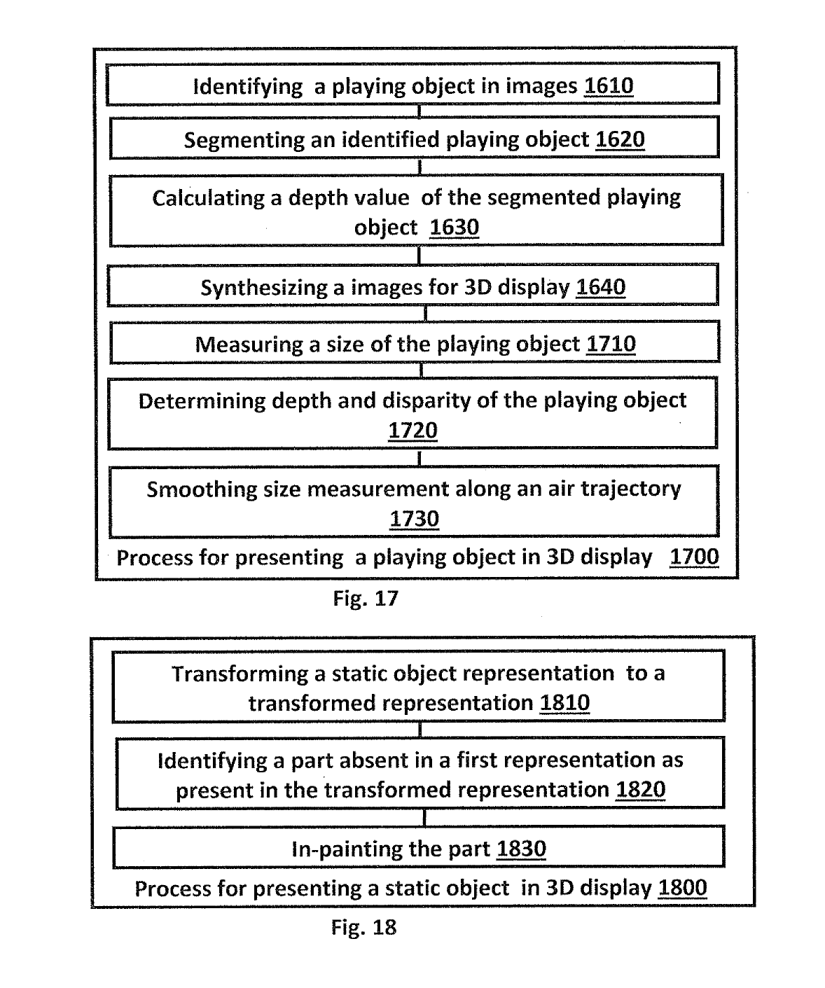

FIG. 17 is a flowchart of a process 1700 for presenting a ball performing an air trajectory 1520. Process 1700 includes a step 1710 of measuring a size of the playing object in the first representation of the playing object, and a step 1720 of determining the depth and the disparity of the object based on its size. Alternatively, process 1700 includes a step 1710 of measuring the size of the playing object in perpendicular to a motion vector associated with the air trajectory. Preferably, process 1700 includes a step 1730 of smoothing the measurements of the size of the playing object based on a monotonous change along the air trajectory.

### Presenting a Static Object in a 3D Display (FIG. 18)

Mapping the off-field portions of the background to a different surface than that of the playing field may significantly enhance the depth perception of the scene. Another method of enhancing the viewer's 3D perception is associated with static on-field object such as the goal post, tennis net, the basket poll, etc. The goal post lies on a different surface than neighboring image elements such as the field or the billboards behind the goal post. To create a correct depth perception, it is important to shift the goal post differently than these image elements. The amount of motion can be readily computed from a goal post model dimensions. However, the different shift requires in-painting of revealed or non-occluded image elements. In-painting means reconstructing deteriorated or lost parts of images and videos.

Referring to FIG. 18, it shows a flow chart of a process 1800 for presenting a static object in a sports scene based on a first image of the sports scene captured at a first viewing configuration, whereas the static object resides on a plane different from the field surface. Process 1800 includes, based on a model of the static object and position relative to other static object, a step 1810 of transforming a first representation of the static object in the first series of images to a second representation fitting a second viewing configuration different from the first viewing configuration, a step 1820 of identifying a part of the static object as being absent in the first representation of the static object, and as being present in the second representation of the static object, and a step 1830 of in-painting that part of the static object.

According to one embodiment revealed image elements are filled-in using prior art in-painting methods. Alternatively, revealed image elements are filled-in using other cameras views as described above.

According to another embodiment, revealed images elements are filled in using prior models of such elements. In the case of field image elements, a model of the field image is used to predict the revealed image elements. In the case of billboards, for example, images of identical billboards from other field locations are used to predict the revealed image elements.

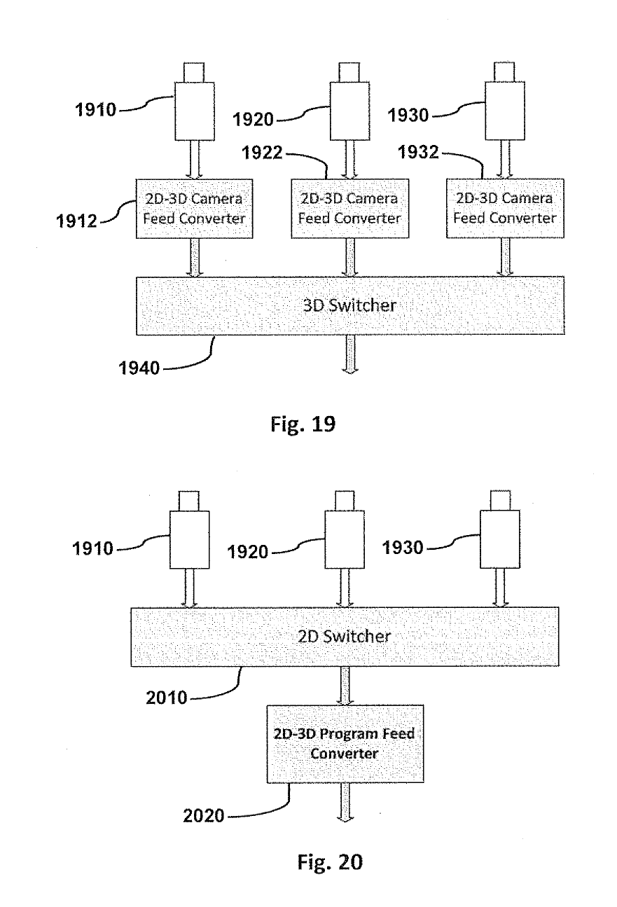

A Method for Generating 3D Video Streams from a Program Feed (FIG. 19-23)

A program feed is generated by switching among multiple cameras. For example, in soccer, such cameras may include a lead camera 1910 with wide angle, a narrow angle high camera 1920, a 16 m camera 1930, a camera behind the goal post, etc, as depicted in FIG. 19. The switching is done by some sort of transition—usually a cut, but sometimes a dissolve, wipe, or other transition. The 2D to 3D transformation may be performed either before switching between the two cameras, or after the switching. In the example of FIG. 19, cameras 1910, 1920 and 1930 feed respective 2D-3D camera feed converters 1912, 1922 and 1932, thus creating three 3D presentations which are delivered to a 3D switcher 1940 for switching between cameras 1910, 1020 and 1930 and thus produce a stream ready for 3D display.

Another situation is depicted in FIG. 20, where cameras 1910, 1920 and 1930 feed a 2D switcher 2010 which combines them to a single video stream or program feed. Here, only the program feed is available to the 2D-3D program feed converter 2020. This is a common situation when converter 2020 is placed at the cable head-end, or near the viewing location—a 3D theatre, a sport-bar or a residential location.

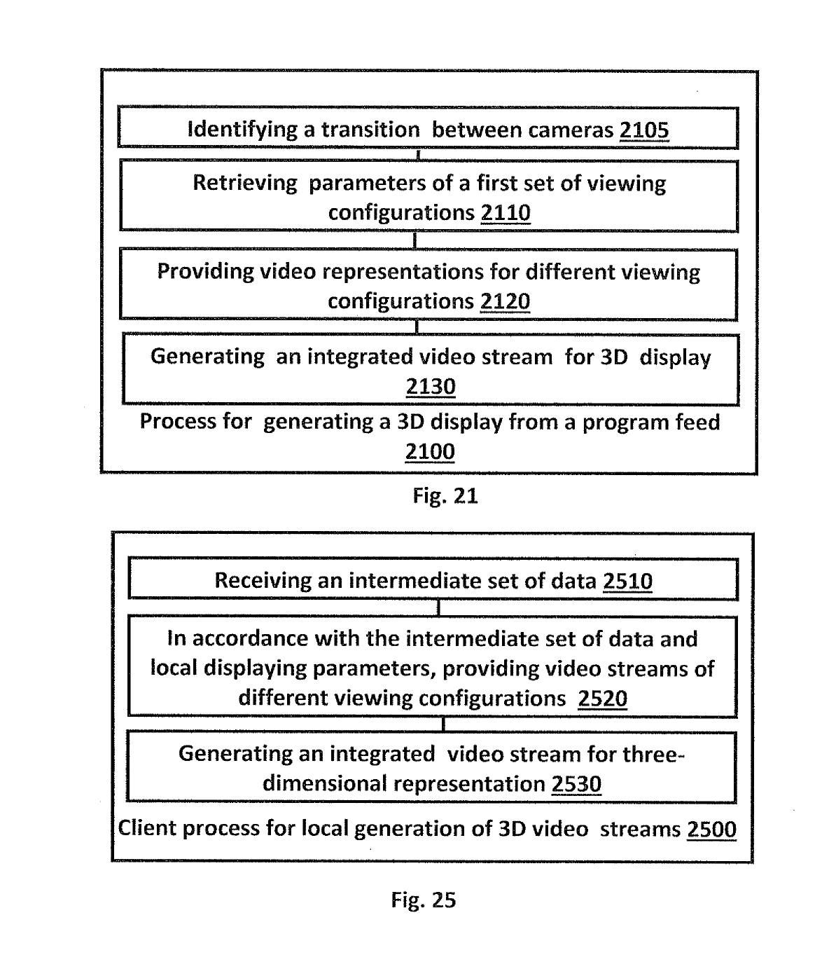

Generating a 3D video stream from a single camera feed, or program feed, may be effected by solving for the camera position, and then tracking camera motion of a continuous basis. FIG. 21 depicts a flowchart for a process 2100 for generating several 3D representations of a scene, whereas the scene is represented by a first video stream captured by several video cameras. Process 2100 includes a step 2105 of identifying a transition between cameras, a step 2110 of retrieving parameters of a first set of viewing configurations, a step 2120 of providing several 3D video representations representing the scene at several sets of viewing configurations different from the first set of viewing configurations, and a step 2130 of generating an integrated video stream enabling 3D display of the scene by integration of at least two video streams having respective sets of viewing configurations, which are mutually different. As described above, camera parameters may be retrieved by analysis of known elements like field lines as captured by the camera.

As it may take the system a few seconds before the viewing configuration is detected, it is desirable that the effective conversion time is significantly reduced, in particular when a large number of cameras is employed and transitions are performed frequently. In the following, systems and methods to obtain such a reduction of the effective conversion time are described.

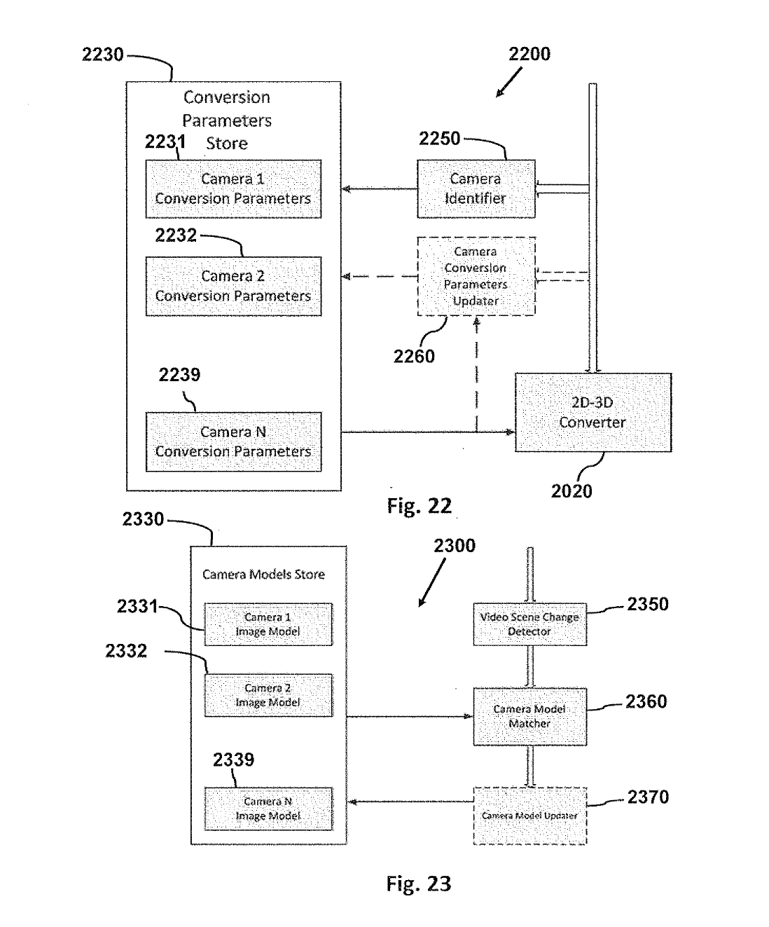

In a system 2200 of FIG. 22, several sets 2231, 2232 and 2239 of camera parameters for respective cameras 1910, 1920 and 1930 are stored in a database 2230. Upon camera switching, the camera identity is identified by a camera identifier 2250, and the appropriate set of conversion parameters is selected. As the conversion parameters may change in time, even for the same camera, a certain adjustment may be required to compensate for the change in these parameters from the last instance in which the same camera was visible. The conversion parameters are continuously adjusted in a tracking process. This adjustment is done by camera updater 2260 and the updated camera parameters are stored in database 2230.

Identification of the current camera may be performed by several methods. Captured objects, like the playing field, may be used for identification of the camera or for finding the camera parameters. Alternatively, the camera code or identifier is encoded with the camera signal and readily extracted by the system from that signal.

In the embodiment of FIG. 23, a system 2300 is used for that sake. Scene or image models 2331, 2332 and 2339, associated with respective cameras 1910, 1920 and 1930 are stored in a database 2330. Upon detection of a camera switch or transition by video scene change detector 2350, the current image or image sequence is compared with all scene models of relevance by camera model matcher 2360 in order to determine the camera currently “on-air”. The camera model may be a symbolic model, like the location and equations of corner points and field lines. Alternatively, it may be multiple images that represent scene field as seen in different configuration of the same camera, or an integrated model such as a panorama image. The system includes a camera model updater 2370 for feeding a new scene model or updating an existing scene model.

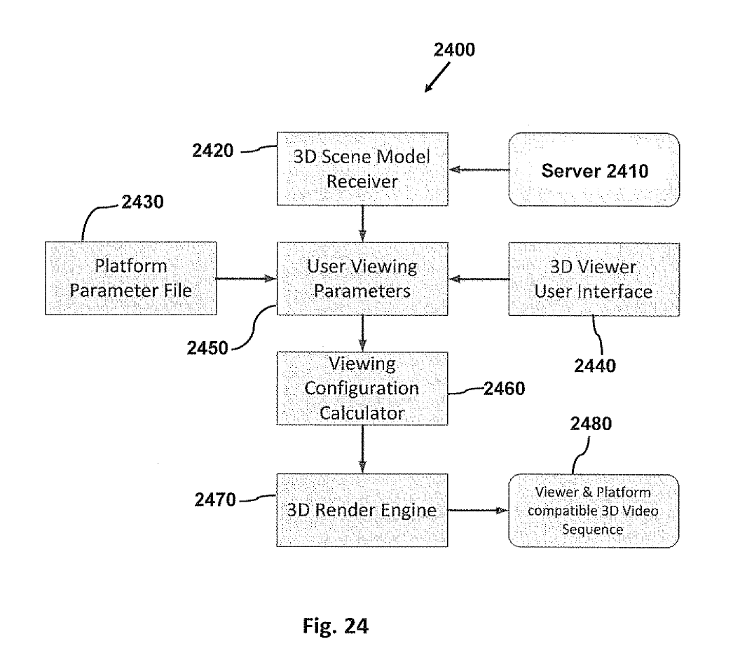

### A Client Process for Producing a 3D Display (FIGS. 24-25)

According to the block diagram of FIG. 24, which describe a system 2400, a remote client having a 3D scene model receiver receives from server 2410 a 3D scene model or an intermediate representation related with a video stream. Consequently, a 3D render engine 2470 renders a 3D view which is compatible with the remote client display characteristic, or a 3D video stream 2480 compatible with a viewer and a platform. As the rendered scene may be displayed on a screen, using a 3D projector, on a home cinema display, computer monitor, tablet display or another device, the 3D view is rendered in accordance with the display size, viewing distance, range of viewing angles, etc. According to the embodiment in FIG. 24, a platform parameter file 2430 is stored on non-volatile memory in the platform, and includes fixed parameters such as display size.

In addition, the viewing configuration may be effected by viewer-induced parameters, such as level of effect, or alternatively by camera baseline and convergence angle. These parameters are provided by the viewer using a 3D viewer user interface 2440. A viewing configuration calculator 2460 receives the platform and viewer parameters and calculates corresponding viewing configuration, for the use of 3D render engine 2470.

Reference is now made to process 2500 of FIG. 25 for generating a local 3D representation of a scene in accordance with local displaying parameters. Process 2500 includes a step 2510 of receiving from a server an intermediate set of data associated with the first video stream, a step 2520 of using local displaying parameter to provide several video streams compatible with different viewing configurations, and a step 2530 of locally generating an integrated video stream enabling 3D display of the scene by integration of two video streams having different respective sets of viewing configurations.

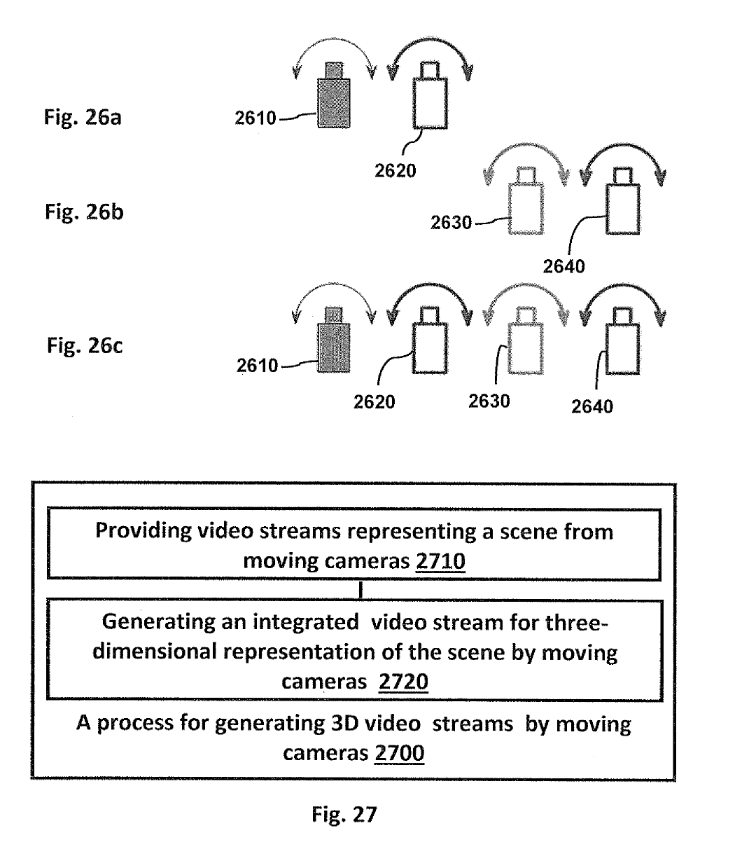

### Generating a Dynamic Viewing Configuration (FIGS. 26-27)

In certain applications it may be desired to compute a 3D display that simulates motion around the real camera position. FIGS. 26a-c depicts a simulated camera motion. First, FIG. 26a presents a real camera 2610 and a generated second view 2620, which together constitute a 3D view. FIG. 26b depicts a fully-generated. 3D view whereas the views for both the left and right eyes, 2630 and 2640, respectively, are generated from real camera view 2610. In a similar way, simulated 3D camera motion is created. A 3D view simulating motion of a 3D camera arrangement is obtained by moving the left camera, for example, in a predetermined path, or in a user-controlled manner, and continuously deriving two viewing configurations for the simulated left and right eyes. For each derived viewing configuration, a 2D image is computed as described above. Together, the left 2D image and right 2D image constitute the 3D view for a specific time instance.

FIG. 26c depicts a simulated 3D camera motion, whereas the viewing configuration moves from the initial configuration which includes real view 2610 and generated view 2620, to a fully generated 3D viewing configuration, which includes virtual views 2630 and 2640. These views support stereoscopic experience by fitting a left eye and a right eye, and support motion experience by simultaneous virtual motion relative to the views of 2610 and 2620 cameras.

In one arrangement, both eye views are generated for a lower 3D virtual cameras. With lower cameras one may get a more pronounced 3D effect. For example, one may segment players from a high viewpoint, when they are on grass background and easier to be segmented, lower the camera generating lower virtual right and left eyes, and then compose the players on a 3D representation such that they are seen with a tribune background.

Reference is now made to process 2700 of FIG. 27 for generating a 3D representation of a scene as seen by a camera pair moving compatibly for creating a 3D display of the scene. The process includes a step 2710 of providing several video streams representing the scene from viewpoints of several moving cameras having a different set of viewing configurations, and a step 2720 of generating an integrated video stream enabling three-dimensional display of the scene by moving cameras.

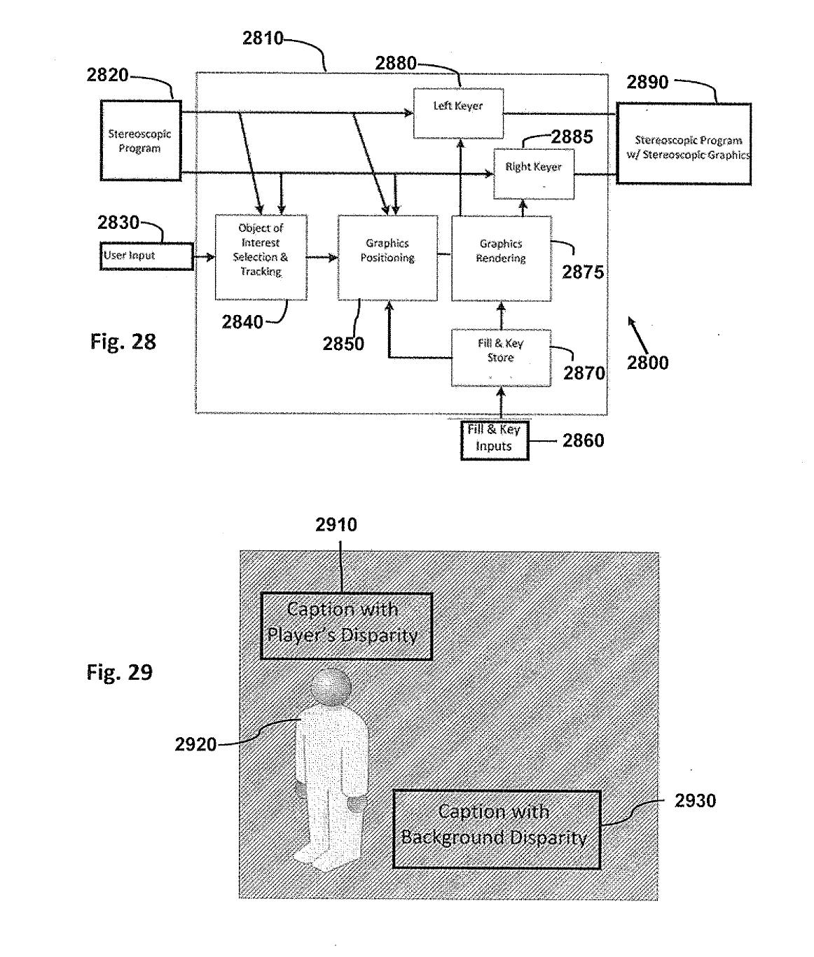

### A Process for Rendering Graphics in the Depth of a Playing Object (FIGS. 28-30)

Two-dimensional (2D) video programs often combine captured video with graphics. One example is sports programs where graphics include a station identifier/logo/watermark, a “live” indicator, a score “bug” or banner at the bottom or the top of the screen etc. In addition to the score, graphics of a shorter duration present a name for the player of interest, certain statistics and other types of information.

Graphic templates are usually prepared offline and inserted into the broadcast image with a character generator: a device or software that produces static or animated text for keying into a video stream. Modern character generators are computer-based, and can generate graphics as well as text and even connect to a video source in order to insert video images in specified locations on the broadcast video frames.

Inserted graphics may be 2D such as a text caption, or may be a 2D projection of a 3D object such as a soda can. As the program signal has no depth, compositing 2D or rendering 3D graphics onto 2D video are done in a similar manner.

The content of inserted graphics is controlled by an external application, such as a statistics application, or by operator control inserting a yellow card graphics, for example. The graphics is keyed-in as an overlay, occluding the captured video content, or mixed with the video content in a semi-transparent manner.

3D programming naturally add a dimension to the viewing experience, which must be reflected in the inserted graphics as well. 2D graphics looks odd when inserted into a 3D program. Furthermore, a viewer focusing on an object of interest in the 3D program located at a certain depth will find it difficult, if not annoying, to view the information presented in the inserted graphics, as the effort to focus on two different depths causes eye strain and headaches.

Stereoscopic 3D graphics comprise left and right graphics channels that are keyed into the respective captured video streams. When the stereoscopic video program is delivered in a side-by-side stereoscopic format, a single graphics engine may generate the left and right graphics, also in a side-by-side format. While these 3D graphics are fairly straightforward to create, the positioning and control of the graphics is a much more complex issue, in view of the changing perspective of the video of the 3D TV programming. For instance, when a program has a near (negative) depth, with the 3D effect appearing to come out of the screen to the viewer, there is a requirement to have the logo positioned in front of the action to maintain a natural perspective. During a sequence with a flat perspective, or a far depth, with the perspective effect going into the distance, the branding graphics need to be just in front of the action.

The Z-depth of a graphic can be changed to best suit a program sequence by adjusting the horizontal separation of the left and right graphics. This method of controlling the Z-depth of elements is often called horizontal image translation. By separating the right and left images of the graphics in one direction, the graphics will appear to come out of the screen. Conversely, when the left and right branding graphics are moved horizontally relative to each other in the other direction, they will appear to move into the screen.

For a fixed scene and camera configuration, one may manually adjust the Z-depth of the graphics to the desired location and keep it there for the duration of the program. However, for a dynamic scene such as a sports event in which the point of interest on the video, like the ball vicinity in a football match, continuously varies its depth value in the course of time, dynamic camera configuration and for a production with multiple camera transitions, the process of manually controlling the Z-depth of the graphics and matching it to the depth of the video point of interest become very tedious for a post-production process and next to impossible for a live broadcasting event.

For that sake, stereoscopic graphics are combined with captured 3D content, by automatically selecting object of interest in the captured 3D content and automatically positioning the stereoscopic graphics in accordance with the location of the object of interest. The object of interest may be a foreground object in the scene, a background of the scene, a surface in the scene, a player or a playing object like a ball.

A variety of methods are available for selecting a human as an object of interest. In an environment where humans are the only moving objects, motion detection as described above may be sufficient to detect an object of interest. In a more complex environment, human detection by means of pattern recognition may be required to ignore non-human moving objects [N. Dalai, B. Triggs, Histograms of Oriented Gradients for Human Detection, IEEE Computer Society Conference on Computer Vision and Pattern Recognition, Vol. 1 (2005), pp. 886-893]. Within the group of humans, a subset of objects of interest may be human facing the camera, which can be distinguished from other humans, by methods of face detection [ref: Robust Real-Time Face Detection] and facial pose estimation as known in prior art [E. Murphy-Chutorian and M Trivedi “Head pose estimation in computer vision: A survey, IEEE Trans. on PAMI, vol. 31, 2009].

In certain application, there may be multiple humans facing the camera, and the object of interest is a talking person which may be the anchorperson in a studio, the guest of a talk show, etc. By analyzing facial dynamics, the speaking person out of a group of persons may be detected [J. M. Rehg, K. P. Murphy, and P. W. Fieguth. Vision-based speaker detection using Bayesian networks. In Proceedings of the Computer Vision and Pattern Recognition, 1999].

In certain applications, it is desired that graphics is attached to a specific person, possibly tagging the video appearance of that person with the person's name. Using prior art methods of facial recognition [Ref: S. Zhou, V. Krueger, R. Chellappa, Probabilistic recognition of human faces from video, Computer Vision and Image Understanding, Vol. 91, 2003, pp. 214-245] a specific person may be located in 2D video images based on recognizing his or her face. In other applications, it may be required to detect a collection of objects such as a crowd, which may be the audience in a sports arena. By applying prior art methods of face detection as described above, multiple faces are detected and a crowd is detected by requiring a certain number of faces to be detected in proximity with an optional face size constraint.

Alternatively, an object of interest may be automatically detected using color-based detection, shape-based detection, graphics-based detection and text-based detection. In a typical sports application, these criteria can be applied solely or jointly. For example, a step of motion detection or human detection may be followed by detecting a player or referee based on costume color, and a specific player based on a Jersey number.

Other objects of interest are a playing object like soccer ball, ice hockey puck, a billboard or display with a specific text or image, a soccer goal post, or a basket. In addition to the methods of detection described above, shape recognition may be used for detecting the playing objects, in-scene text detection and graphics detection may be used for static object detection, followed by color detection and shape detection.

Also, an object of interest may be determined based on detecting at least two objects and determining their mutual relationships, such as the player with the soccer ball, the goalkeeper near the goalpost. An object of interest may be designated by the operator, thereby enabling to position interested graphics with respect to a large variety of object. Similarly, an object or area of interest may be implicitly designated by a cameraman who keeps it in focus, while objects farther away (in the depth dimension) from that object or area seem blurred or defocused. Using edge points and their gradient magnitude as a measure for focus, image areas which are in focus are detected (Du-Ming Tsai and Hu-Jong Wang, Segmenting focused objects in complex visual images, Pattern Recognition Letters, Volume 19, Issue 10, August 1998, Pages 929-940).

As objects in the scene may move or the camera may translate, pan, tilt or zoom, it is not sufficient to detect or designate the object of interest only once, but it has to be tracked continuously. Acquiring or designating the object in each frame may be a time consuming process, not guaranteed to be successful due to self and mutual occlusions as well as noise. Object tracking as known in prior art is used to provide object location between consecutive detections as described above.

Given an object of interest in a 2D image which is one of a stereoscopic image pair, its 3D location may be determined using prior art methods of 3D reconstruction [R. Hartley, A. Zisserman, Multiple View Geometry, Cambridge University Press, 2000]. The 2D location of the object in the other image lies on an “epiploar line”, which is computed from the 2D image location of the selected object in the 1^{st} image and the relative positioning of the two cameras. Using a measure of similarity such as image area correlation, the 2^{nd} image location is readily found along that line. [Brown et al., Advances in Computational Stereo, IEEE Trans. PAMI, 25 no. 8, pp. 993-1008, 2003].

Given a matching pair of left and right image location and the relative positioning of the two cameras, the 3D location is readily solved using the method of triangulation. It may occur that a stereo camera calibration is not available from the physical setup, for example when only the stereoscopic program is available. In such a case it is possible to match multiple points between the two images and solve for the stereo cameras model, as known in prior art.

A playing object, like a soccer ball, is of particular interest for highlighting with graphics, in sports video. One form of highlighting may be an arrow designating the ball. Another form of highlighting may be a statistics caption such as speed, distance traveled, etc.

For finding the 3D location of an object of interest, a 3D model may be first constructed from an image pair, using prior art techniques of stereoscopic reconstruction which result in a depth map. Then, objects of interest are detected in 3D. For example, it is possible to detect foreground object against background surfaces which are located farther away, by looking for discontinuities (edges) in the depth map. Once an object is detected and segmented from the depth map, its 3D location is readily available.

Referring now to system 2800 of FIG. 28, a 3D processor 2810 facilitates positioning stereoscopic graphics in stereoscopic video. Stereoscopic program provider 2820 provides Left and Right program streams. A user input interface 2830 may provide some control to a module 2840 for selection and tracking of an object of interest. A graphics positioning module 2850 receives the left and right video stream. An operator uses a fill and key input interface 2860 to feed a fill and key storage 2870 by a fixed graphics, a logo, a template for a player's name, a score or other statistics. The graphics is fed to graphics positioning module 2850 and graphics rendering module 2875. The left keyer image 2880 and right image keyer 2885 embed the graphics in the program, which is fed to a storage 2890 for Stereoscopic program with Stereoscopic graphics.

The 3D location of the object of interest determined as described above, is used to position the stereoscopic graphics. One may predefine a positioning template and apply it to the object at hand. For example, it may be desired to place graphical caption 2910 above a player 2920, as shown in FIG. 29. In that case, once the 3D location is determined, caption 2910 is placed at the point of interest, at depth which equals the player's depth and at a location which is above the player. In contrast, caption 2930 is placed with background disparity and depth.

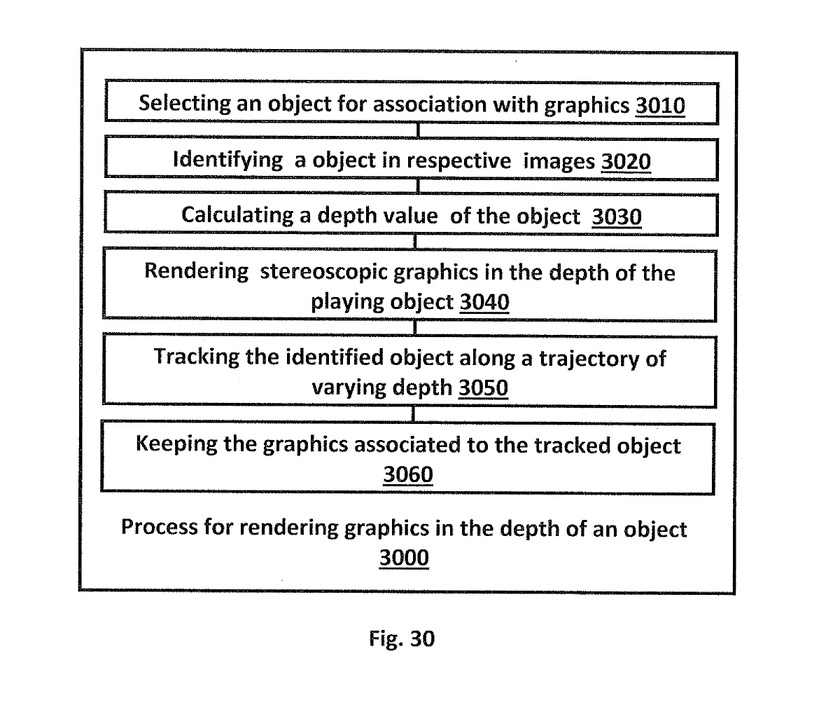

Reference is now made to FIG. 30, which shows a flow chart of a process 3000 for rendering graphics in the depth of a playing object. Process 3000 includes a step 3010 of selecting an object in a first series of images, a step 3020 of identifying the object in respective images, a step 3030 of calculating a depth value of the object, and a step 3040 of rendering the graphics in accordance with a depth value of the object.

In some embodiments, process 3000 also includes a step 3050 of tracking the identified object along a trajectory of varying depth, and a step 3060 of keeping the graphics associated to the tracked object.

A template may include the graphics size, for example setting the graphics width to be 100 cm. As graphics are positioned in 3D world, the scaling from a 3D quantity to its image equivalent is straightforward. Furthermore, the inserted graphics entity can be modeled as a 3D object and a 3D Computer Graphics system is used to render its left and right views.

In the case of highlighting the playing object, the highlighting graphics, such as an arrow, is scaled based on the ball's size and is oriented in 3D with respect to the ball, chasing or tracking the ball in 3D space, for example.

Using a fixed graphics location with respect to the selected object of interest has its drawbacks. For example, another player may be located or running above the selected player of interest and insertion of graphics may interfere with the display of that player. For that sake, the area surrounding the object is searched for an insertion area which is free of other moving objects, and graphics are inserted in that area and at the correct depth.

Similarly, the area surrounding the object is searched for insertion area which has better contrast with the inserted graphics, for example, light-colored background for insertion of dark-colored graphics.

When there are not enough landmarks to solve for the camera model, 2D-3D conversion may be based on segmentation of the 2D image sequence into surfaces and assigning a disparity equation to each of these surfaces, in order to “paint” the converted image based on that disparity map. The graphics object is positioned at an image position relative to the object and at a disparity equation derived from the object or relative to its neighboring surfaces, as designated when the graphics template is designed for that object. For example, as depicted in FIG. 29, graphics 2910 may be positioned above the head of player 2920 at a disparity equation derived from the player, such that graphics 2910 is perceived as floating above the player's head. Alternatively, graphics 2930 may be placed at the player's feet, using a disparity equation derived from the playing surface and shall be perceived as lying on the playing surface or background.

The graphic elements may be animated and rotated, resulting in larger variety of artistic effect. Furthermore, it may be that 3D graphics are positioned at a depth where some of the captured objects are indeed in front of the graphics, it may look peculiar that a farther object like the graphics occludes a nearer object. For a natural-looking integration of 3D graphics with the 3D video it is required to reconstruct a depth map from the stereoscopic views, represent the graphics as a 3D surface and render the depth map and the graphics surfaces using a 3D graphics system which resolve the occlusion using prior art method of a depth buffer.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. In particular, the present invention is not limited in any way by the examples described.

1-39. (canceled)

40. A method for generating a three-dimensional representation of a scene, the scene being represented by a first video stream captured by a certain camera at a first set of viewing configurations, the method comprising:
(a) segmenting a portion of an object from a rest portion of a frame;
(b) processing the segmented portion of the object; and
(c) embedding the processed portion of the object in a frame of an integrated video stream enabling three-dimensional display of the scene.

41. The method of claim 40 wherein the method includes a process for generating one or more three-dimensional representations of a scene, the first video stream captured by two or more video cameras, the process comprising:
(A) identifying a transition between a first camera and a second camera of the two or more video cameras;
(B) retrieving parameters of a certain set of viewing configurations associated with said second camera;
(C) based on at least the retrieved parameters of the certain set of viewing configurations, providing one or more video streams representing the scene at one or more respective sets of viewing configurations different from said certain set of viewing configurations; and
(D) generating an integrated video stream enabling three-dimensional display of the scene by integration of at least two video streams selected from the group of video streams consisting of the first video stream and the one or more provided video streams, the sets of viewing configurations related to the selected video streams being mutually different.

42. The method of claim 40 wherein the method includes a process for synthesizing an image of at least one portion of an object from a first image of the at least one portion of the object, the first image being at least a part of a frame captured by a certain camera at a first viewing configuration, the process comprising:
(A) segmenting at least the at least one portion of the object from a rest portion of a frame;
(B) assigning a three-dimensional model to the at least one portion of the object;
(C) in accordance with said three-dimensional model, calculating a modified image of said at least one portion of the object from a viewing configuration different from said first viewing configuration; and
(D) embedding said modified image in a frame of an integrated video stream enabling three-dimensional display of the scene.

43. The method of claim 42 wherein said three-dimensional model is selected from the group of three-dimensional models consisting of:
(i) a flat surface;
(ii) a cylinder;
(iii) an elongated body having an uniform elliptical cross-section; and
(iv) a three dimensional human shape model.

44. The method of claim 42 wherein said three-dimensional model is a three-dimensional shape model represented as a collection of surface patches.

45. The method of claim 40 wherein the method includes a process for synthesizing an image of a on-field object captured in two or more frames by a certain camera at a first set of viewing configuration of a sports scene, the on-field object being identified in a first certain frame of said two or more frames, the first certain frame being transformed to a first respective frame associated with a different set of viewing configurations, the first viewing configuration and said different set of viewing configurations being suitable for two eye stereoscopy, the process comprising:
(A) identifying the on-field object in a second certain frame of said two or more frames;
(B) transforming at least a portion of said second frame to a second respective frame associated with the different set of viewing configurations; and
(C) embedding said on-field object in said second respective frame such that:
(i) said second certain frame of the two or more frames and said second respective frame fitting two eye stereoscopy; and
(ii) the resulted second respective frame being different from a frame obtained by transforming the whole second frame in accordance with said different set of viewing configurations.

46. The method of claim 45 wherein said identifying the on-field object in a second certain frame is facilitated by at least one method of a group of method consisting of:
(I) footing locations in both said first certain frame and said second certain frame;
(II) object tracking between subsequent frames; and
(III) identifying a feature associated with said first object in both said first certain frame and said second certain frame.

47. The method of claim 45 wherein a disparity value distribution of the embedded on-field object is determined in accordance with a calculated disparity value distribution of an surface underlying said on-field object.

48. The method of claim 47 wherein the disparity value distribution of the embedded said on-field object is perturbed in a series of frames having said different set of viewing configurations around a calculated disparity value distribution of the underlying surface, the perturbations are by a small differential disparity value such as to visually separate said first object from said underlying surface, and the disparity value distribution of the embedded on-field object is modified continuously between a frame having separated on-field objects and a frame where the on-field objects are not separated.

49. The method of claim 40 wherein the method includes a process for presenting a playing object in a sports scene from a first series of images of the sports scene, the first series of images captured at a respective first set of viewing configurations of the sports scene, the process comprising:
(A) identifying the playing object in the first series of images to get identified playing objects in respective images;
(B) segmenting an identified playing object from the rest of a respective image;
(C) calculating at least one depth value associated with the segmented playing object; and
(D) synthesizing a second series of images of the playing object fitting a second set of viewing configurations using for each image of the second series the respective calculated at least one depth value, said second set of viewing configuration being different from the first set of viewing configurations, the different viewing configuration supporting a three-dimensional display of the sports scene.

50. The method of claim 49 wherein said playing object is identified using at least one method of a group of methods consisting of color based detection, shape based detection and motion based detection.

51. The method of claim 49 wherein the process includes transforming a first representation of an air trajectory of said playing object as captured in the first series of images to a second representation of said air trajectory in accordance with the second set of the viewing configurations.

52. The method of claim 51 wherein the process includes:
(i) based on said first representation of said air trajectory, determining world representation of a plane disposed vertical to an horizontal plane and hosting said air trajectory;
(ii) calculating world representation of said air trajectory, based on said world representation of the plane; and
(iii) calculating disparity values along said air trajectory in accordance with the second set of viewing configurations based on the calculated world representation of said air trajectory.

53. The method of claim 52 wherein the process includes:
(iv) determining on-field endpoints of said air trajectory.

54. The method of claim 49 wherein the process includes at least one step of:
(i) measuring a size of said playing object in the first representation of the playing object;
(ii) determining the depth and the disparity of said object based on its size;
(iii) measuring said size of the playing object in perpendicular to a motion vector associated with said air trajectory; and
(iv) smoothing the measurements of said size of said playing object based on a monotonous change along the air trajectory.

55. The method of claim 49 wherein a graphic element is embedded within the first and second series of images by:
(i) selecting an object of interest in the first series of images; and
(ii) rendering the graphic element in accordance with a depth value of said object of interest within the first and second series of images.

56. The method of claim 40 wherein the method includes a process for presenting a static object in a sports scene based on a first image of the sports scene captured at a first viewing configuration, the static object residing in part on a plane different from the field surface, the process comprising:
(A) based on a model of the static object and its position relative to other static object, transforming a first representation of the static object in the first series of images to a second representation fitting a second viewing configuration different from said first viewing configuration; and
(B) identifying a part of said static object as being absent in said first representation of said static object, and as being present in said second representation of said static object.

57. The method of claim 56 wherein the method further includes:
(C) in-painting said part of said static object.

58. The method of claim 56 wherein the method includes in-painting said part based on at least one source of a group of sources consisting of:
(i) an image captured at a viewing configuration different from the first viewing configuration;
(ii) a prior model of the static object; and
(iii) a similar object located in a other field location.

59. The method of claim 56 wherein the static object is selected from a group of objects consisting of a goal post, a tennis net, a basket poll, a billboard, a gallery, a balcony and a tribune.
